(19) United States
(12) Patent Application Publication
(10) Pub. No.: US 2023/0105466 A1
(43) Pub. Date: Apr. 6, 2023

(54) SYSTEMS AND METHODS FOR AERIAL VEHICLE (AV) FLIGHT CONTROL

(71) Applicant: CLEO ROBOTICS INC., Boston, MA (US)

(72) Inventors: Omar Eleryan, Boston, MA (US); Simon Czamota, Boston, MA (US)

(21) Appl. No.: 17/959,047

(22) Filed: Oct. 3, 2022

Related U.S. Application Data
(60) Provisional application No. 63/251,515, filed on Oct. 1, 2021.

(51) Int. Cl. B64C 9/02; B64D 35/00; B64D 27/24; G05D 1/10

(52) U.S. Cl. CPC B64C 9/02; B64D 35/00; B64D 27/24; G05D 1/101

(57) ABSTRACT

Systems, methods, and apparatuses for an aerial vehicle (AV). The AV can include a frame structure comprising an upper frame, a lower frame, and bridges connecting the upper frame and the lower frame. The upper frame can include a housing for electrical components. The AV can include a duct extending from the upper frame to the lower frame. The AV can include a motor to rotate the propeller. The AV can include guides located between the bridges and the duct. A portion of the guides can include a non-linear path. The AV can include actuators. The AV can include flaps, coupled to the guides and the actuators, configured to protrude from the lower frame or retract into the frame structure. The flaps can curve along at least one of a horizontal axis or a vertical axis of the flaps. The flaps can overlap with each other when protruded.

### CROSS-REFERENCE TO RELATED APPLICATION

This application claims priority under 35 U.S.C. § 119 to U.S. provisional patent Application No. 63/251,515 filed on Oct. 1, 2021, the entirety of which is incorporated by reference herein.

### BACKGROUND

An aerial vehicle can be controlled via a device or a controller. The aerial vehicle can receive instructions or commands from the controller to trigger a pre-configured or pre-installed function. The aerial vehicle can perform flight operations based on the instructions. The aerial vehicle can generate lift to increase elevation aerially and direct air in different directions to control the flight path.

### SUMMARY

In some examples, an (AV) includes a frame structure; a duct extending at least partially within the frame structure; at least one motor configured to rotate at least one propeller within the duct, the duct at least partially defining an airflow pathway; and/or a plurality of flaps positioned relative to the plurality of paths, at least one of the plurality of flaps configured to move to at least partially redirect the airflow pathway. The AV can further include at least one vent configured to receive air moved by the at least one propeller within the duct, the air received within the at least one vent creating passive cooling for one or more electrical components. Moreover, the frame structure further can comprise a plurality of bridges connecting an upper portion of the frame structure to a lower portion of the frame structure to form a plurality of openings between the upper portion and the lower portion.

In some instances, the AV includes a controller configured to: detect a temperature of a housing of the AV; responsive to the temperature of the housing being greater than a temperature threshold, initiate a cooling protocol configured to reduce the temperature of the housing without increasing an altitude of the AV; and/or cause a rate of rotation of the at least one propeller to increase or decrease based on the cooling protocol. Furthermore, the controller can be configured to: adjust, based on feedback data of one or more sensors, the rate of rotation of the at least one propeller to at least one of increase or decrease the altitude of the AV; and/or adjust, based on the feedback data, a level of protrusion of one or more of the plurality of flaps to redirect the AV. Additionally, the AV can include at least one battery unit forming an aerodynamic portion of at least one of the upper portion or a lower portion of the frame structure, the at least one battery unit providing power to one or more electrical components of the AV.

In some examples, the one or more electrical components are disposed in a first housing, and the at least one battery unit is disposed in at least one of a second housing, a third housing, or a fourth housing for one or more battery cells, the first housing, the second housing, the third housing, and the fourth housing form the upper portion. In other iterations, the one or more electrical components are disposed in a first housing, a second housing or more, and along the at least one battery unit form the upper portion. Additionally or alternatively, the duct can have a flared shape from the upper portion to a lower portion of the frame structure, such that an upper end of the duct comprises a smaller diameter than a lower end of the duct, the flared shape of the duct redirecting airflow towards an inner wall of the duct. In some scenarios, the at least one propeller comprises a first propeller adjacent to an upper end of the duct and a second propeller adjacent to a lower end of the duct, the first propeller being smaller than the second propeller. Moreover, the AV can include a detachable cover between the upper portion and a lower portion of the frame structure to cover a plurality of openings formed by a plurality of bridges between the upper portion and the lower portion. The detachable cover can include one or more active or passive components to provide a supplemental capability to the AV, the one or more active or passive components including at least one of an antennas, a sensor, or an actuator. At least one of the plurality of flaps can, for instance, comprise a rigid guide portion to couple with at least one of the plurality of guides providing retractability for the at least one of the plurality of flaps. By way of example, the plurality of flaps can be disposed proximate to a lower frame of the frame structure and a lower end of the duct to redirect airflow in a predetermined direction to control movement of the AV. Moreover, a plurality of actuators can drive the plurality of flaps to protrude or retract via the plurality of guides.

In some instances, a system comprises an aerial vehicle (AV) including a frame structure comprising one or more housings for one or more electrical components configured to control movement of the AV; a duct coupled to the frame structure having a flared shape defining an airflow path; at least one motor coupled to the one or more electrical components and at least one propeller, the at least one motor configured to rotate the at least one propeller directed along the airflow path; a plurality of actuators coupled to the frame structure and the one or more electrical components; and/or a plurality of flaps, coupled to a plurality of guides and the plurality of actuators, configured to protrude into or retract from the airflow path via the plurality of guides. In some examples, the frame structure further includes a plurality of bridges connecting an upper portion and a lower portion to form a plurality of openings between the upper portion and the lower portion. Additionally, a pitch of at least one blade of the at least one propeller can have cyclical or collective control to change the thrust vector direction omitting a usage of the plurality of flaps or aiding the plurality of flaps. Moreover, the system can further include a plurality of guides located between the plurality of bridges of the frame structure and the duct, at least one of the plurality of guides forming a path for at least one of the plurality of flaps.

In some scenarios, a method of controlling an aerial vehicle (AV) includes directing air through a duct using one or more propellers, the duct being coupled to a frame structure of the AV, a flared shape of the duct at least partially defining an airflow path; moving the AV at a velocity generated by directing the air along the airflow path at least partially defined by the flared shape; and/or changing the velocity at least partially by changing a direction of at least a portion of the air along an inner surface of the duct. Changing the velocity can include at least one of moving one or more flaps of a plurality of flaps to at least partially redirect the airflow path; or protruding the plurality of flaps such that the plurality of flaps overlap with one another. In some examples, the direction of at least a portion of the airflow is changed by changing an orientation of the one or more propellers. Additionally, the method can further comprise detecting a temperature at a location within the AV; in response to detecting the temperature, increasing a rotational velocity of the one or more propellers; and receiving an increase of air through one or more vents, the increase in air generated by increasing the rotational velocity of the one or more propellers and causing the temperate to decrease. By way of examples, changing the velocity can include collectively or cyclically controlling a pitch of the at least one blade of the at least one propeller to change a thrust vector direction while omitting a usage of the plurality of flaps.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 shows an example aerial vehicle (AV).

FIG. 2 shows the AV with an example a protruding flap.

FIG. 3 is a cross-sectional side view of the AV.

FIG. 4 is a perspective view of the AV.

FIG. 5 shows an example battery of the AV.

FIG. 6 illustrates the AV without the battery shown.

FIG. 7 is a perspective view of an example frame structure of the AV.

FIG. 8 is a dissected view of the AV.

FIG. 9 is a top view of the AV.

FIG. 10 depicts an example mechanism for driving the flaps.

FIG. 11 shows an example flap of the AV.

FIG. 12 illustrates the AV with example guides as bridges.

FIG. 13 shows the AV with an example duct as a bridge.

FIG. 14 shows the AV with example guides on a side of the duct.

FIG. 15 shows example overlapping flaps of the AV.

FIG. 16 depicts example partially inserted flaps of the AV.

FIG. 17A illustrates an example airflow path.

FIG. 17B shows an example airflow path when a flap is protruded.

FIG. 17C is a flow diagram of the AV with an example flow separation in crosswinds or forward travel.

FIG. 17D depicts an example top propeller blades rotated to reduce flow separation.

FIG. 17E shows example top propeller blades rotated to induce a non-vertical airflow direction when a flap is protruded.

FIG. 17F shows a bottom propeller blade rotated to induce a non-vertical airflow direction when another flap is protruded.

FIG. 17G shows example top and bottom propeller blades tilted to reduce flow separation.

FIG. 17H illustrates example top and bottom propeller blades tilted to induce a non-vertical airflow direction when a flap is protruded.

FIG. 17I shows an example top and bottom propeller blades tilted to increase at least one of the lateral or vertical velocities of the AV.

FIG. 18 is a flow diagram of an example method of operating the AV.

FIG. 19 is a flow diagram of an example method of reducing thermal of the AV.

FIG. 20 is a block diagram illustrating an architecture for a computer system that can be employed to implement various aspects of the presently disclosed technology.

FIG. 21 is a block diagram illustrating an example method of controlling an aerial vehicle.

FIG. 22 is a block diagram illustrating an example method of controlling an aerial vehicle.

### DETAILED DESCRIPTION

Following below are more detailed descriptions of various concepts related to, and implementations of, systems, methods, and apparatus of an aerial vehicle (AV) flight control via a non-uniform duct and protruding flaps. The various concepts introduced above and discussed in greater detail below may be implemented in any of numerous ways. This technology is directed to systems, methods, and apparatus for an AV flight control via a non-uniform duct and protruding flaps. Certain structures or designs of the aerial vehicles may hinder their functionalities (e.g., versatility or mobility) due to excess weight and inefficient airflow (e.g., trajectory redirection or usage). For instance, due to excess weight, the aerial vehicles may consume more power for flight control and mobility of the aerial vehicle may be impacted negatively. In another example, the design choice of aerial vehicles may affect how the airflow is directed away from the aerial vehicles, such as limiting the angle at which the air is expelled from the aerial vehicle, further affecting flight control.

Systems, methods, and apparatus of this technical solution can provide an AV having an open design (e.g., a frame with exposure to interior components) to reduce the weight of the housing or chassis of the AV. The reduction of weight can increase the mobility, agility, and battery performance of the AV. The systems, methods, and apparatus provide a non-uniformed duct to increase the amount of control moment generated by the protruding flaps. The control moment can correspond to or be associated with a thrust vector directed by the protruding flaps. The systems, methods, and apparatus provide flaps that may be flexible to protrude in a linear or non-linear path to adjust the angularity (e.g., degree) of which the airflow is projected from the AV. In some instances (e.g., with a non-linear path), the AV can increase the protrusion of the flaps which can increase the angle of the flaps to increase the magnitude of redirecting the airflow, thereby enhancing the momentum shifts and velocity of the AV. Thus, the AV of this technical solution can provide enhanced control performance (e.g., mobility, agility, battery, etc.) and airflow efficiency (e.g., utilization of the airflow traversing via the duct).

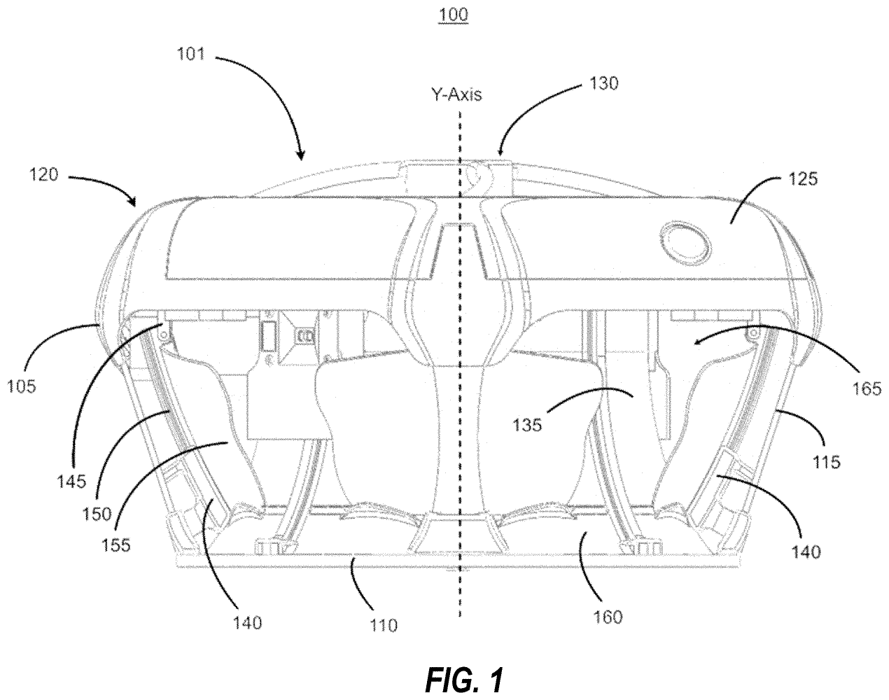

Referring now to FIG. 1, an example illustration 100 of an AV 101 is shown. The AV 101 can include or be installed or constructed with hardware, software, or a combination of hardware and software components. The AV 101 can be referred to generally as a vehicle, a drone, a flying object, or a flight machine. The AV 101 can include a frame structure including an upper frame or upper portion 105, a lower frame or lower portion 110, and/or various bridges 115. In some instances, the frame structure includes the upper portion 105 and omits the lower portion 110 and bridges 115. Alternatively, the upper portion 105 and the lower portion 110 can be connected together via the bridges 115. In some cases, the upper portion 105 may be referred to as a first frame, a top frame, or an upper chassis. The upper portion 105, the lower portion 110, and the bridges 115 may be referred to generally as a first part, a second part, and a third part of the frame structure of the AV 101, respectively. Further, the lower portion 110 may be referred to as a second frame, a lower portion, or a lower chassis, for example. The upper portion 105 and the lower portion 110 can be semi-toroidal, substantially toroidal or toroidal. For example, toroidal can refer to a ring-like shape, such that the axis of revolution passes through the hollow center of the AV 101. In further example, a rectangle, a cylinder, or a combination of various shapes can be rotated around an axis parallel to one of its edges or sides to produce or form a hollow section extending about the vertical axis of the toroidal shape. The hollow center can be extended from the upper portion 105 to the lower portion 110 via the duct 135. For example, one or more portions of the upper portion 105 can be circular or ring-shaped. In some cases, the upper frame can be polygonal, for example, octagonal or hexagonal. In some cases, the upper portion can be non-uniform and/or can include several shapes. The frame structure may be a fuselage with an open body housing various components of the AV 101. With the open body (e.g., removed excess portions of the body or fuselage), the AV 101 can provide an increased flight time and payload (e.g., storage or space for housing electronics, etc.) capacity due to weight reduction.

The upper portion 105 can connect or be coupled to the lower portion 110 via one or more bridges 115 to form one or more openings 165. For example, bridges 115 can be spaced apart from one another such that an opening 165 forms between the bridges 115 and the upper portion 105 and the lower portion 110. In some cases, plastic, cloth or fabric-like cover can be provided to cover the openings 165. The cover can be removable, affixed, and/or removably coupled to one or more portions of the upper frame 115, lower portion 110, or bridges 115. The cover can enclose or partially enclose the openings 165. In some cases, the cover can be waterproof or air-tight, while in other cases the cover may be permeable. In other cases, the cover can be an aerodynamic component to reduce drag and enhance flight performance. In yet other cases the cover can contain additional components such as sensors, antennas, electronic components, or actuators with surfaces which can enhance the performance of the AV 101 or provide additional capabilities.

The AV 101 can include at least a housing 120, a battery 125, a bridge 130, a duct 135, one or more guides 140, one or more linkages 145, one or more spines 150, one or more flaps 155, one or more lower tabs 160, one or more motors, one or more propellers, one or more sensors, and one or more actuators. The components of the AV 101 (e.g., the frame structure, the housing 120, the battery 125, the bridge 130, the duct 135, etc.) can be composed or constructed of titanium, aluminum, steel, carbon fiber, copper, plastic, rubber, polymers, among other materials. One or more components or structures of the AV 101 can be aerodynamic, such as the upper portion 105, the battery 125, the duct 135, the housing 120, the lower portion 110, and/or the bridges 115, for example. The AV 101 or part of the AV 101 can be flexible, rigid, or a combination or in-between flexible and rigid depending on the materials used for constructing the one or more components.

The one or more motors can be mounted on the bridge 130 (sometimes referred to as an overpass). The motor can be installed at other locations of the AV 101 to provide torque or rotation to at least one propeller. For example, the motor can be operatively coupled to at least one propeller for rotating the propeller. The motor can extend from the bridge 130 (e.g., the center of the bridge 130 equidistant from the edges of the upper portion 105) vertically to into the duct 135 to couple with the propeller, where the propeller can rotate at a portion of the duct 135. The motor may be an electric motor such as a brushless DC electric motor, alternatively, a brushed DC electric motor or any other type of electric motor.

The motor may be controlled by an electrical component (e.g., flight control system or speed controller) of the AV 101. For example, the motor can drive at least one propeller about the vertical axis within the duct 135 to draw air into the upper end of the duct 135 and to push air out of the duct 135 through the lower end (e.g., draw air into the upper portion 105 and out the lower portion 110). The process of the airflow can include pulling air into and out of the frame structure. Drawing air into the duct 135 and pushing air out the lower end of the duct 135 may also be referred to herein as airflow within the duct 135. Modulating an output of the at least one motor can modulate the rotational speed of the at least one propeller, which in turn modulates the lifting force that acts upon the AV 101. In some cases, the upper portion 105 can include a different housing 120 or enclosure installed or coupled to the upper portion 105. For example, the AV 101 can include an enclosure to carry a payload, items, or other components on the AV 101.

The AV 101 can include one propeller or multiple propellers. The propeller can be constructed with similar or different materials from other hardware components of the AV 101. Each propeller can be attached, coupled, or installed to a respective motor. In other instances, one motor can be coupled to more than one propeller. The propeller can be positioned in the duct 135 (or extended into the duct) via the motor. The propeller can include one or more blades. The propeller can be referred to as a fan. The propeller can receive torque from the motor to rotate to generate lift force, thrust, or airflow (e.g., pushing air from the upper end to the lower end of the duct 135).

In some cases, where multiple propellers are included in the AV 101, a first propeller adjacent to the upper end of the duct 135 may be smaller (e.g., smaller diameter) than a second propeller closer to the lower end of the duct 135. In some other cases, the propellers can be the same diameter. The propellers can be positioned in any portions within the duct 135. In some cases, each propeller may include a different number of blades. The AV 101 can include any number of propellers (e.g., AV 101 with one propeller, two propellers, or three propellers). The propellers may rotate in opposite directions, which may also be referred to herein as counter-rotating. In some cases, the propellers may rotate in the same direction. In other cases, the propellers might change their rotation direction in mid operation. If there are two or more propellers, the yaw of the AV 101 may be controlled by a differential rotational rate of the two or more propellers.

The AV 101 can include one or more sensors, such as a velocity sensor, visual sensor (e.g., a camera), distance sensor, depth sensor, infrared sensor, temperature sensor, acceleration sensor, gyro sensor (e.g., gyroscope), compass sensor, torque sensor, altitude sensor, pressure sensor, power sensor, an Inertial Measurement Unit (IMU), an optical flow sensor, among other sensors to capture data or control the AV 101 as discussed herein. For example, the velocity sensor can measure the travel speed of the AV 101 and the visual sensor can capture footage to provide visual feedback to operators or administrators. In another example, the altitude or pressure sensor can measure the altitude, the gyro sensor can capture the angular velocity, and the temperature sensor can capture the temperature of the AV 101.

The sensors can be embedded on or installed to one or more components of the AV 101, such as the battery 125, the housing 120, the frame structure, the duct, among others. For example, the temperature sensor installed in the housing 120 can measure the temperature of the housing 120 or electrical components of the AV 101. In another example, the visual sensor can be mounted on or installed in at least one of the housing 120, the battery 125, the upper portion 105, or one of the bridges 115. One or more sensors can be included as part of the electrical component of the AV 101, such as situated or maintained in the housing 120. In some iterations, more than one housing 120 can house various components of the AV 101 and may house various payloads.

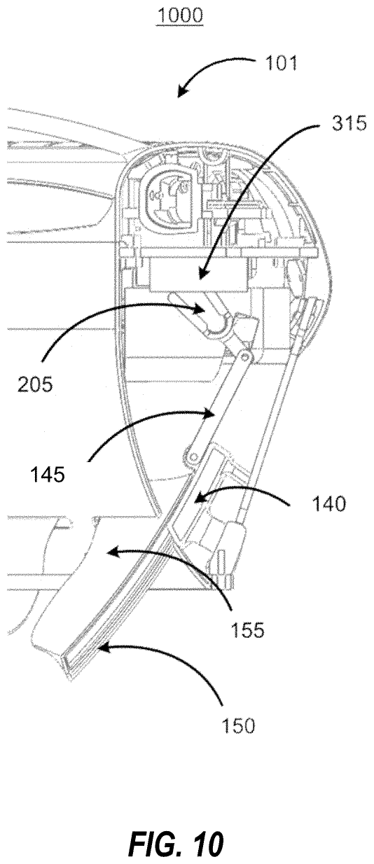

The one or more actuators can be coupled to the frame structure and the one or more electrical components. For example, the actuators can couple to the inner portion of the frame structure, such as the upper portion 105. In another example, the actuators can couple or are adjacent to the electrical component to receive instructions. The one or more actuators can include features or functionalities similar to, as part of, or in addition to the motor. For example, the actuators can provide rotation, torque, or movement for the linkage system driving the flaps 155. The linkage system can include at least an arm and a linkage 145 (as discussed in further detail in at least FIG. 10). The actuator may be referred to as a servo, a linkage motor, or a propeller driver. The actuators can perform or use any features or functionalities to drive the flaps 155, such as controlling the extent of the protrusion or retract the flaps 155. The actuators can be coupled to an arm connected to the linkage 145, and the spine 150 of the flap 155. The actuators may also be linear motors or other actuators which connect directly to and drive each flap 155 without the need for a linkage system.

The at least one housing 120 can be coupled to or be a part of the upper portion 105. The at least one housing 120 can include, house, store, or maintain one or more electrical components (or other mechanisms) of the AV 101. The at least one housing 120 can encapsulate the electrical components. The electrical components can include at least a printed circuit board (PCB) which can include one or more microprocessors, a wireless transmitter-receiver (WTR) unit, one or more antennas, one or more electronic speed controllers, one or more inertial measurement units (IMU), one or more sensors, or any combination thereof. The electrical component can control one or more operations of the AV 101, such as operating the AV 101. The operations (e.g., flight operations) can include increasing the altitude or elevation, changing direction, or increasing the velocity of the AV 101. The electrical component can control the operation of the AV 101 via the controller, as discussed herein. The one or more antennas can be mounted to one or more components of the AV 101 such as the at least one housing 120, the frame structure, the duct, among others.

For example, the electrical component can receive instructions from a remote device or obtain instructions installed or stored in the local storage. The electrical component can include a controller to control one or more components of the AV 101 based on the instructions. Herein, activities, functions, tasks, or operations, performed by the controller or any electronics of the electrical component can generally refer to the electrical component performing the operations. As an example, the electrical component (e.g., the controller) can instruct the motor to increase the rate of rotation (e.g., rotation per minute (RPM)) of the propeller to increase the velocity or altitude of the AV 101. In further example, the electrical component can instruct one or more actuators to drive the one or more flaps 155 to protrude or retract based on which flight path to take. The extent of the protrusion can indicate or reflect the magnitude of the flight path, such as the angularity, speed, or sharpness of performing a turn or moving in certain directions). The controller can perform the controls based on instructions from a remote device (e.g., client device) or pre-configured instructions. In some cases, the controller can perform the instructions based on an artificial intelligence (AI) system running onboard the AV 101 and/or remotely.

The blades of the at least one propeller driven by the at least one motor can be tilted or their pitch may be changed (or both) in such a way that directs the thrust vector away from the vertical axis of the AV. During normal operation, the airflow flowing through the duct can become separated at the duct inlet, along the duct wall, or at the duct exit, impacting the performance of the AV as well as the magnitude of the airflow redirection by the flaps. The thrust vector created by the tilting of the propellers can counteract or at least reduce the flow separation at any point of the airflow path through the duct. The propellers can be used to vector airflow within duct 135, or at the outlet depending on where the propeller is located, the shape of the duct, the desired performance and the operating conditions of the AV. In some cases, the thrust can be vectored towards a flap to increase the airflow towards the flap which can increase the amount of control generated by that flap when protruded. In other iterations, the thrust may be vectored away from the flap and in the direction of the intended thrust vector that is generated by that flap. In yet other iterations the tilted propellers can be used in lieu of the flaps to redirect the airflow coming out of the duct and provide control over the lateral velocity of the vehicle. When more than one propeller are present, the more than one propeller may be vectored in the same direction, opposite directions, or not vectored at all. In some iterations, the propellers may be vectored to reduce, delay or eliminate flow separation along one or more sections of the duct wall.

The propeller can be tilted using a mechanical swashplate, hinge, actuator, or any other mechanism that allows the propeller or its blades to tilt along a desired rotation and induce a thrust vector. A mechanical swashplate can be used which uses a servo or any other actuator to directly drive and control the cyclic or collective pitch of each blade. In other iterations the individual blades can be mounted on hinges along an axis and the motor speed can be pulsed in such a way that the blades tilt along the axis of the hinge throughout each rotation resulting in a vectored thrust. In other iterations the entire motor and propeller assembly can be tilted using an actuator instead of the individual blades. A position feedback sensor can be present which can detect the location of the propeller within a single revolution and feed this information to the electrical component for control.

The electrical component can be included, situated, or installed in the housing 120 or other portions within the frame structure. In some cases, the electrical component can be installed with software or functions indicating the control of at least the motor and the actuator(s) to achieve a pre-determined operation. The electrical component can perform flight control or operation. The electrical component can include devices or other electronics that can perform features or functionalities of the AV 101 discussed herein. For example, the electrical component can identify or determine that an amount of RPM of the propeller can reflect or result in a predetermined velocity or altitude. The electrical component can take into account environmental factors, such as wind speed, temperature, humidity, and altitude, to determine the RPM to reach an instructed altitude or speed. Further, the electrical component can take into account features of the AV 101, such as the diameter of the duct, the RPM of the propellers, the angle and protrusion of the flaps, the number of flaps available, or the number of propellers of the AV 101. In another example, the electrical component can determine that an amount of protrusion of one or more flaps 155 can reflect a predetermined trajectory or angle of the airflow from the propeller. Accordingly, the electrical component can control the airflow expelling from the AV 101 to control the flight path (e.g., direction, velocity, etc.). The electrical component can provide other features or functionalities to instruct the motor, actuator, or other components of the AV 101 to control the flight of the AV 101.

In further example, the electrical component can receive sensor data (e.g., data from one or more sensors). The sensor data can be feedback data of the one or more sensors, such as during flight. The controller of the electrical component can adjust the rate of rotation or RPM of the propeller based on the sensor data. For instance, the controller can determine a first altitude of the AV 101. The controller can be instructed to adjust the altitude of the AV 101 to a second altitude. Accordingly, the controller can adjust the RPM of the propeller to increase or decrease the altitude of the AV 101 to the altitude according to the instructions.

In another example, the feedback data from the sensor can include the direction and velocity of the AV 101. The controller can receive instructions to turn or move the vehicle in a certain direction. Based on the instructions and the feedback data, the controller can adjust the level of protrusion of one or more flaps 155 to redirect the AV 101 towards a certain direction. Further, by adjusting the one or more flaps 155, the controller can control the velocity of the AV 101 moving towards the instructed direction.

In some cases, the electrical component can include autonomous flight features or functionalities (e.g., AI functions) for flight control based on feedback data. In this case, the electrical component can perform feature recognition or object detection techniques. For instance, during flight, the AV 101 may detect an object obstructing the path flight. Accordingly, based on this feedback data, the controller can provide instructions to avoid collisions. In some cases, the controller can adjust the altitude of the AV 101 to move over or under the obstruction. In some cases, the controller can adjust one or more flaps 155 to protrude or retract for the AV 101 to move around the object. In a third case, the controller can adjust one or more flaps 155 to stop the AV 101 before the collisions or adjacent to the obstruction (e.g., without decreasing elevation). In some cases, the electrical component can transmit a signal or notification to the remote device indicating the obstruction, such that a user of the remote device can transmit additional instruction or response. The AV 101 (or electrical component of the AV 101) may perform other autonomous flight procedures or operations. The AV 101 may include different operation modes, such as autonomy mode or remote-operated mode, for example. The control software of the electrical component may be modified, updated, or replaced by a remote operation unit (e.g., a remote device) or via over the air updates.

The battery 125 may be referred to as a power source to provide power to the AV 101 or components of the AV 101. The at least one battery 125 can be aerodynamic, and can have a similar shape to other portions of the AV 101. The at least one battery 125 can be coupled to, included, installed on, or attached to the upper portion 105, the at least one housing 120, or a combination of the upper portion 105, and the at least one housing 120. The at least one battery 125 can be detachable from the upper portion 105 and the at least one housing 120. In some cases, the at least one battery 125 can couple to the upper portion 105 or the at least one housing 120 using any coupling mechanism, such as magnet, clip, lock, or other coupling or locking techniques. In combination, the at least one battery 125, the at least one housing 120, and the upper portion 105 may represent at least a part of the upper portion of the AV 101 having a toroidal shape. In some cases, the upper portion 105 can refer to or correspond to the upper portion of the AV 101. For example, the housing 120 can be a first housing and the at least one battery 125 can be a second, third or fourth housings. The first housing and the remaining housings can form the upper portion 105. In other cases the power source can be made up of multiple separate batteries that each maintain and follow the aforementioned specifications and properties. Additionally or alternatively, one or more batteries may form a full circle or partial circle defining the upper portion 105 and/or the electrical components may be disposed under the one or more batteries. In some instances, the battery compartment can be at least a portion of the lower portion 110.

In some cases, the battery 125 can be a shell or housing for maintaining battery cells or other types of batteries (e.g., lead, lithium, etc.). The cells within the battery 125 can include different sizes. The battery 125 can be electrically connected to one or more components of the AV 101, such as the propeller, the motor, the actuator, sensors, or other electrical components of the AV 101. The battery 125 can include any number of battery cells, such as one, two, three, five, or ten battery cells. In some cases, with multiple cells, one or more cells may be used without using at least one available cell.

The battery 125 can be replaceable (e.g., attachable and detachable). The battery 125 can be held within a housing or battery housing using one or more techniques. For example, the battery 125 can be held in place via friction or gravity. The battery 125 can be held in place via an adhesive. In some cases, the battery 125 can include any type of latch mechanism to couple with at least one of the housing 120 or the upper portion 105 (e.g., which may include or support the latch mechanism). For instance, the battery 125 can include a latch or a button to unhook or decouple from the AV 101. In another case, the housing 120 can include the latch of the latch mechanism to release or detach the battery from the housing 120 and the upper portion 105 of the frame structure. Accordingly, the battery 125 can be replaced. In some cases, the latch mechanism can be located at the housing 120 or other locations of the upper portion of the AV 101.

The battery 125 may or may not have uniform weight distribution. For example, all sides of the battery 125 may have a similar weight or mass. In some cases, certain side(s) of the battery 125 may not be distributed similarly in weight. The weight of the battery 125 can be uniformed with the housing 120 (e.g., including the electrical components of the housing 120). Hence, the housing 120 and the battery 125 can provide uniform weight distribution on any side of the AV 101. In this case, as an example, the center of gravity of the AV 101 may be uniformed horizontally. With the upper portion 105 coupled to or installed with the housing 120 and the battery 125, the center of gravity can be closer to the upper portion of the AV 101 (e.g., center of gravity near the upper portion 105 or vertically higher). The installment of the housing 120 or the battery 125 can be based on any optimal weight distribution for the operation of the AV 101. In the event the weight distribution due to the battery 125, or other components of the AV 101 is non-uniform, the controller of the AV 101 can adjust the propeller speed or flaps 155 to account for the non-uniform weight distribution in order to move the AV 101 along a desired flat path.

The bridge 130 can be positioned adjacent to the upper portion 105, the bottom portion 110, or the duct 135. The bridge 130 can be installed on or attached to the upper portion 105, the bottom portion 110, or anywhere along the duct 135. The bridge 130 can couple to at least one motor and at least one propeller. In some cases, there may be a plurality of bridges 130 to support more than one motor. For example, the bridge 130 can provide a structure for the motor or the propeller to position in the duct 135 and at the center of the duct 135 (e.g., longitudinally centered). The bridge 130 can include one or more arms extending to the upper portion 105, the bottom portion 110, or the wall of the duct 135. The space between the arms of the bridge 130 can be hollow or covered with a mesh made up of any material such as metal, plastic, or cloth to prevent foreign object entry into the duct 135 and interfering with the operation of the at least one motor and at least one propeller when the bridge is located adjacent to the upper portion 105 or the bottom portion 110.

The duct 135 can provide a hollow structure at the center of the AV 101 (e.g., from a top-down view). The duct 135 can interconnect the upper portion 105 and the lower portion 110 of the frame structure (e.g., in addition to the bridges 115). The duct 135 can extend from the upper portion 105 to the lower portion 110. The duct 135 can include at least an upper end, a lower end, and an inner facing wall surface that extends between the two ends. The inner diameter (ID) of the duct can be represented by the distance between two opposed points on the inner facing wall surface of the duct 135. The ID of the duct 135 may also be referred to herein as the internal diameter (ID) of the first AV 101. In some cases, the duct 135 may be a circular cross-sectional shape (e.g., from a top plan view). In some instances the duct 135 can extend from frame structure at least partially below the upper portion 105. In some scenarios the AV 101 can only include an upper portion 105 and/or can omit the lower portion 110. A bottom portion of the duct 135 can form the lower portion 110 and/or perform some of the operations of the lower portion 110 described herein. The duct 135 can define an airflow pathway for air moved by the one or more propellers, for instance using a flared shape.

For example, the ID of the duct 135 may be between about 30 mm and about 130 mm. The ID of the duct 135 may be larger or smaller at each end relative to each other or relative to other portions of the duct 135. In some cases, the upper end of the duct 135 may include a smaller diameter than the lower end of the duct 135. For example, the duct 135 may have a cross-sectional shape (from a side elevation view) that is wider or narrower at both or at one of the ends relative to other portions of the duct 135. In some implementations, the duct 135 having different diameters at each end may form a non-uniform shape and/or a flared shape. For example, the duct 135 can flare from an upper end to the lower end or from the upper portion 105 to the lower portion 110 of the frame structure. Accordingly, the duct can include an upper end having a smaller diameter than the lower end, for example, or vice versa. The flaring of the duct 135 can be constant (e.g., from 30 mm to 40 mm to 50 mm, respectively) or non-constant (e.g., from 30 mm to 45 mm to 80 mm, respectively).

In some cases, the duct 135 can also include a middle section with a constant diameter between the upper end and the lower end of the duct. The duct may include other iterations, such as having a middle section with a constricting diameter or multiple sections of various diameters. For example, the duct diameter from top to bottom could be 30 mm to 25 mm to 40 mm. In some cases, different portions of the duct 135 can include different diameters. The different portions can include at least a top portion, a middle portion, or a lower portion of the duct 135 (sometimes referred to as a first portion, a second portion, and a third portion, respectively). For example, the top portion can include a diameter greater than or less than the middle portion. The middle portion can include a diameter greater than or less than the lower portion. The lower portion can include a diameter greater than or less than the top portion. In some cases, the upper portion of the duct 135 can include similar diameter formed by at least the housing 120 and the battery 125. In other cases the duct 135 can have more than three portions, such as an upper portion, an upper propeller portion which recedes into the duct 135 allowing the propeller to come closer to the edges of the duct wall, a middle portion, and a bottom portion.

The duct 135 can situate at least one propeller having a diameter similar to the duct 135 without contacting the inner wall of the duct 135. For example, with a duct 135 diameter of 40 mm, the diameter of the propeller may be up to 39.99 mm or closer to 40 mm. In another example, with at least two propellers (e.g., a first propeller adjacent to an upper end of the duct 135 and a second propeller adjacent to a lower end of the duct 135), the first propeller can have a first diameter close to the upper end and the second propeller can have a second diameter close to the lower end. The first propeller may be smaller than the second propeller based on the flare of the duct 135. In some instances, the first propeller can be a same size as the second propeller, or the first propeller may be larger than the second propeller. The one or more propellers can further include a third propeller, a fourth propeller, and so forth of similar or differing sizes.

By having a duct 135 flaring at least at the lower end, the airflow can follow the curvature of one or more inner walls of the duct 135 (e.g., Coanda effect) thereby causing some of the air exiting the lower end of the duct 135 to flow in a direction away from the vertical central axis of the duct 135. One or more flaps 155 can protrude to intersect with the airflow from the duct 135. For example, the flap 155 can protrude to capture and redirect air away from one side of the duct, thereby reducing or eliminating the airflow along the curved surface (e.g., along the duct 135) on the side of the protruded flap 155. The redirected air or the reduction in airflow along the curved surface (e.g., or the combination of the redirected air and the reduction in airflow) below the protruded flap 155 can increase the amount of control in pitch and/or roll generated by the protruding flap 155. Hence, the flap 155 and the duct 135 flaring at least at the lower end can enhance the movement, speed, agility and controllability of the AV.

Without being bound by any particular theory, having a duct 135 flaring at the lower end, the duct 135 can direct the airflow closer to the inner wall of the duct (e.g., Coanda effect), thereby allowing more airflow to be captured and redirected by one or more of the protruded flaps 155 to enhance the movement of the AV 101. Further, the thrust performance and the overall aerodynamic properties of the AV 101 can be enhanced.

The duct 135 can extend along axis y of the AV 101 orthogonal to the horizontal plane. In some cases, the AV 101 can have a center of gravity along the vertical axis. The center of gravity may also be referred to herein as the center of mass. The AV 101 can include a center of gravity along the vertical axis at the high-point or at least above the mid-point of the AV 101. The airflow within the duct 135 can create a lifting force that causes the AV 101 to move along the vertical axis. The lifting force may also be referred to herein as thrust. The airflow within the duct 135 and onto the flaps 155 can create an angular force that redirects the AV 101 in a predetermined direction.

The guide 140 can be coupled to, installed at, or adjacent to the lower portion 110 or the bridge 115 of the frame structure. The guide 140 can be located between the bridges 115 of the frame structure and the duct 135. The guide 140 may be referred to as a track to steer the flaps 155 in certain directions or angles. The guide 140 can be configured to guide the flaps 155 when protruding or retracting. For example, the guide 140 can couple or engage with a rigid guide portion on the flap 155, such as the spine 150 of the flap 155. Additionally or alternatively, the rigid guide portion can be formed on a side of the flap 155, along a center of the flap 155, or any other predefined path on the flap 155 for guiding a retractable path for the flap 155. The entire flap 155 may be rigid or only portions of the flap 155 such as the rigid guide portion. Engaging with the spine 150 or rigid guide portion of the flap 155 can improve the precision with which the flaps 155 are protruded or retracted, providing a retractability for the flap 155. The guide 140 can provide a path for the flap to drive, such as when the actuator pushes the flap 155 to extend out of the frame structure or pull the flap 155 into the frame structure. The guide 140 may include a non-linear path (e.g., curved or bent path), such that the flaps 155 are more angled towards the duct 135 as the flaps 155 are extending from the frame structure. In some cases, increasing the angle of the flaps 155 can increase the redirection of the airflow towards a certain direction, thereby increasing horizontal movement mobility. In some cases, at least some of the portions of the guide 140 may be non-linear. In some cases there may be more than one guide for each flap, for example, there may be first guide on a first side of the flap and a second guide on the second side of the flap.

The linkage 145 may be a part of the linkage system. The linkage 145 may be referred to as an arm, a second arm, or an extension between the actuator and the spine 150 of the flap 155. The linkage 145 can be operated by the actuator to drive the flap 155. For example, the linkage 145 can be connected to a first arm installed on the actuator. Upon initiation of the actuator, the linkage 145 can move the flap 155 per instructions.

The spine 150 can be a part of the flap 155 (e.g., supporting structure of the flap 155). The spine 150 can be connected or attached to the flap 155 to provide a rigid structure to control the flap 155. The spine 150 can be configured to couple with the guide 140. The spine 150 can couple to the linkage 145 to receive a driving force from the actuator, such as to drive the flap 155. In some cases the flap may have no spine, and/or can use its edges to travel along the guides to maintain the predetermined path.

The flap 155 may be referred to or regarded as a flight control surface or a wing of the AV 101 to redirect the airflow in a predetermined direction. The AV 101 can include any number of flap 155, such as four, five, eight, etc. The flap 155 can be driven by the actuator via the linkage system or linkage mechanism, such as any type of linkage structure, or directly by an actuator such as a linear servo attached directly to the flap without the use of a linkage. The flap 155 can redirect airflow from the duct 135. For example, the flap 155 can redirect the airflow from the duct based on the angle and the level of protrusion of the flap 155. Depending on which flap 155 is extended, the AV 101 can be propelled in a direction that corresponds to the moment of the thrust vector generated by the extended flap 155 or the resultant thrust vector generated by the extended flaps 155 and/or the other flaps (e.g., when multiple flaps are protruded).

The flaps 155 can be coupled to the guide 140 via the respective spine 150 of the flaps 155. The flaps 155 can couple to the actuators via the spine 150 connecting to at least the linkage 145. The flaps 155 can be configured to protrude from the lower portion 110 or the lower end of the duct 135. Similarly, the flaps 155 can be configured to retract into the frame structure in a similar path as the protrusion. The flaps 155 may be curved along different axes, such as along the horizontal axis and the vertical axis of the flaps 155. Flaps 155 that are curved in both the horizontal axis and the vertical axis can allow for more efficient storage of the flaps 155 within the frame structure as the flaps 155 can angle towards the duct 135 when in the retracted state.

In some cases, when protruding all flaps 155 synchronously with the same RPM of the propeller, the thrust generated by the AV 101 may decrease. In this case, the controller can increase the RPM of the propeller without increasing altitude by synchronously protruding all flaps 155. Synchronously protruding all flaps 155 can refer to protruding the flaps 155 to the same length or extension. In some cases, the controller can control multiple flaps 155 to extend symmetrically on at least two axes (e.g., front, back, and sides) to increase the RPM of the propeller while maintaining the altitude of the AV 101.

The flaps 155 may be flexible or constructed with flexible material. For example, the flaps 155 can be constructed, formed with, or include flexible materials such as plastic or rubber. In some cases, the flaps 155 can be constructed with a malleable material, such as a plastic, a composite, a metal or metal alloy that can deform. The flaps 155 can be configured to overlap with each other when protruded, such as to minimize, reduce, or prevent gaps between each of the adjacent flaps 155. For instance, minimizing gaps between the flaps 155 during protrusion can prevent airflow from escaping between the protruded flaps 155 to enhance capturing airflow redirection. The flaps 155 can protrude or retract adjacent to or at the lower end of the duct 135. In some cases, if the lower portion 110 is part of the duct 135 (e.g., lower tab 160 as part of the duct 135), the flaps 155 may retract into or protrude out of the duct 135. The flaps 155 can extend in a linear or a non-linear manner based on the path of the guide 140. The flaps 155 can extend out from the frame structure into the exhaust area of the duct 135 to alter airflow from or through the duct 135. The positions of each flap 155 relative to the duct 135 and relative to the other flaps 155 of the AV 101 can control pitch, roll, or both of the AV 101.

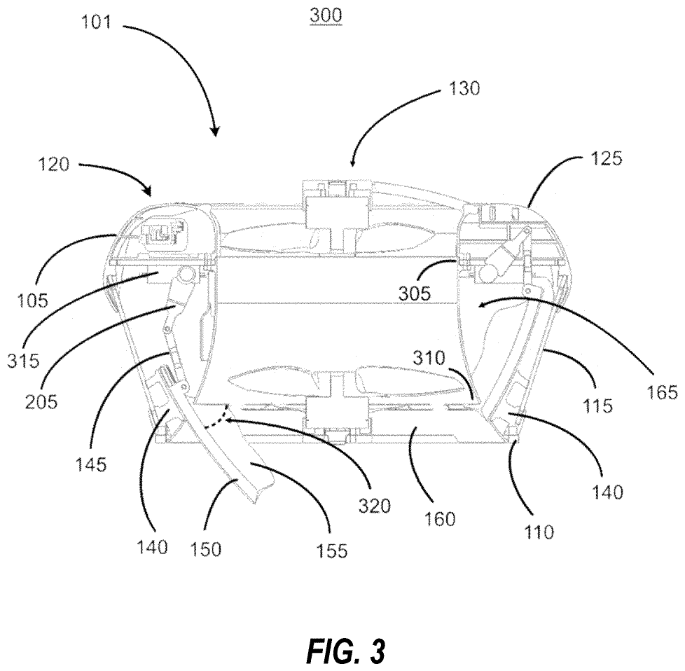

The flaps 155 can be flush with respect to the lower portion 110 or the lower end of the duct 135 when fully retracted. In some instances, it is advantageous to keep the flaps 155 partially protruded (e.g. 10-30%) so that a retracted position omits full retraction from the duct 135. In other instances, the flaps can have an initial or start position at a partially protruded position and can, in some instances, retract fully when the opposite flaps are fully protruded (e.g., to perform a maneuver or navigation control action). The inner surface of the flaps 155 (e.g., the surface facing the duct 135) may be adjacent to or brush against the lower end of the duct 135. For instance, the flaps 155 may be adjacent to the lower portion 110 of the frame structure or the lower end of the duct 135, such as when protruded. Accordingly, by extending one or more flaps 155 in the path of the airflow from the duct 135, the flaps 155 can redirect airflow in a predetermined direction to control the movement of the AV 101. The angle of incidence (e.g., angle 320 in conjunction with FIG. 3) between the flaps 155 and the lower end of the duct 135 may be different based on how extended the flaps 155 are from the frame structure. For example, the angle of incidence 320 can decrease as the flaps 155 protrude further, thereby redirecting more airflow from the duct 135. In some cases, the flaps 155 may protrude in the path of the duct 135 with the same angle of incidence based on at least a segment of the protrusion process.

The flaps 155 can include any dimensions based on the size of the AV 101. For example, the larger the AV 101, the larger the flaps 155. With smaller flaps 155, the AV 101 may include an additional number of flaps 155 to cover all portions (e.g., lower end portion) of the duct 135. In some cases, the number of flaps 155 can be based on the number of bridges 115 of the frame structure. Accordingly, the dimension of the flaps 155 may be bigger or smaller to cover the opening of the duct 135 based on the number of bridges 115. In some cases, the flaps 155 may be concave or convex in their planer, upper surface shape, or other non-flat shaped. In some cases, the flaps 155 or other components (e.g., frame structure, housing 120, battery 125, guides 140 etc.) of the AV 101 may be coated with an aerodynamic substance, such as to reduce drag during flight.

The positions at which the flaps 155 are extended or retracted may be referred to as a percentage of extension or retraction. For example, 100% extension can refer to fully extending the flap 155 to the max extension. Extending the flap at different amounts of extension >0% up to 100% can cause varying effect on flight. In some cases, the different amounts of extension can provide different angles of incidence between the flaps 155 and the duct 135, which can cause further effects on the flight. The flaps 155 can be controlled by the electronic component (e.g., the controller) via commands to the actuators coupled to the flaps 155.

The lower tab 160 can be a portion installed on or coupled to the lower portion 110 and the lower end of the duct 135. The lower tab 160 can be a part of the duct 135. The lower tab 160 may provide support for allowing airflow to transition further from the duct 135 to the lower portion 110. In some cases, the lower tab 160 may be a part of the duct 135 (e.g., an extension of the duct 135). There can be gaps between the lower tab 160 and the duct 135 for the flaps 155 to protrude from or retract into the frame structure. In some cases, the flaps 155 may be designed, sized, or constructed with dimensions to fit the gaps between the lower tab 160 and the duct 135. The lower tab 160 can extend the duct 135 (e.g., be a part of the duct 135) to facilitate airflow to exit the duct 135 away from the center of the duct 135. The lower tab 160 can be a continuation or an extension of the duct 135. The lower tab 160 may be adjacent to the flaps 155. In some cases, the lower tab 160 may brush against the flaps 155 during the drive of the flaps 155.

In some cases, the AV 101 can include one or more detachable covers (not shown). The detachable cover can be referred to generally as a cover, shell, shield, or a wrap. The cover can be composed of any material, such as cloth, carbon fiber, plastic, etc. The material of the cover can be similar to or different from the material of the AV 101 construction or components of the AV 101. The detachable cover can be situated, coupled, or attached between the upper portion 105, the lower portion 110, and the bridges 115. The detachable cover can at least partially cover the openings 165 between the upper portion 105 and the lower portion 110 of the frame structure. For example, each “open” portion (e.g., opening 165) of the frame structure can be represented by the upper portion 105, the lower portion 110, and two consecutive bridges 115. The AV 101 can be configured to couple an attachable or removable cover to any open portion of the frame structure, such as to provide a closed-body design for the AV 101. In some cases, the cover can conceal at least a portion of the interior of the frame structure. In some cases the covers can contain additional electronic components such as sensors, antennas, or actuators to provide additional or supplemental capability or improve performance of the AV 101. For instance, the additional components may add a supplemental data collection capability (e.g., with an additional imaging, object, or motion detection sensor), a supplemental communication capability (e.g., with an additional antenna and/or communication interface, for instance, to connect to a cellular network), and/or a supplemental mechanical capability (e.g., with an additional actuator to move a sensor, propellor, wheel, or other component).

The AV 101 can include one or more legs or struts located on the bottom of the AV 101 attached to the lower portion 110. The presence of these structs can protect the flaps 155 from striking the ground or other surfaces during takeoff and landing. The one or more struts can be located anywhere along the perimeter of the lower portion of the duct 135 or extend from any part of the frame to below the lower portion 110. In some iterations the struts can be coupled to actuators which can retract the struts for storage after takeoff and lower them during landing or at any point during flight.

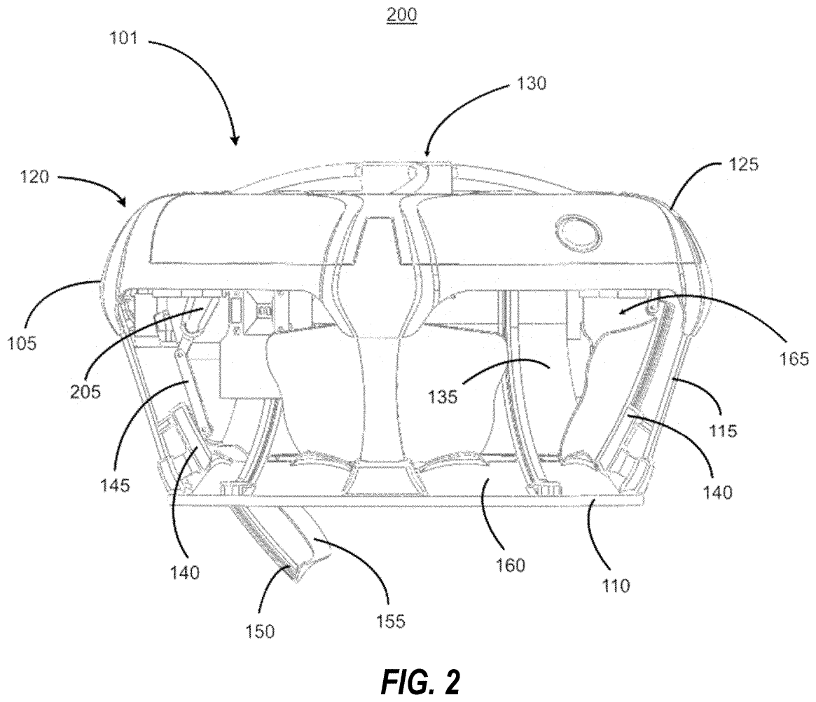

FIG. 2 is an example illustration 200 of the AV 101 with a protruding flap. The illustration 200 can include the AV 101 with similar components in conjunction with FIG. 1. The AV 101 can include an arm 205 of the actuator or servo. The arm 205 may be referred to as a servo arm or an actuator arm. The arm 205 can be coupled directly to the actuator and linkage 145. The arm 205 can be rotated by the actuator. In response to a rotation, the arm 205 can move the linkage 145 to drive the flap 155. As shown, as an example, the arm 205 moved the linkage 145 to drive the flap 155 out of the frame structure. The flap 155 can be guided by the guide 140 in a non-linear path. Accordingly, the arm 205 can move the linkage to redirect the airflow path from the duct to redirect the AV 101.

FIG. 3 is an example illustration 300 of a cross-sectional side view of the AV 101. Illustration 300 can include a cross-sectional view of the duct 135. The duct 135 can include an upper end 305 and a lower end 310. In some cases, the upper end 305 of the duct 135 can correspond to or start at the upper portion 105 of the frame structure. In some other cases, the upper end 305 of the duct 135 can start at the upper portion of at least the housing 120 or the battery 125. The lower end 310 of the duct 135 can be adjacent to the guide 140 or the inner surface of the flap 155. In some cases, the lower end 310 can correspond to the lower tab 160. In some cases, the lower end 310 can correspond to the lower portion 110. Illustration 300 can include an example illustration of the actuator 315. The actuator 315 may be referred to as a servo.

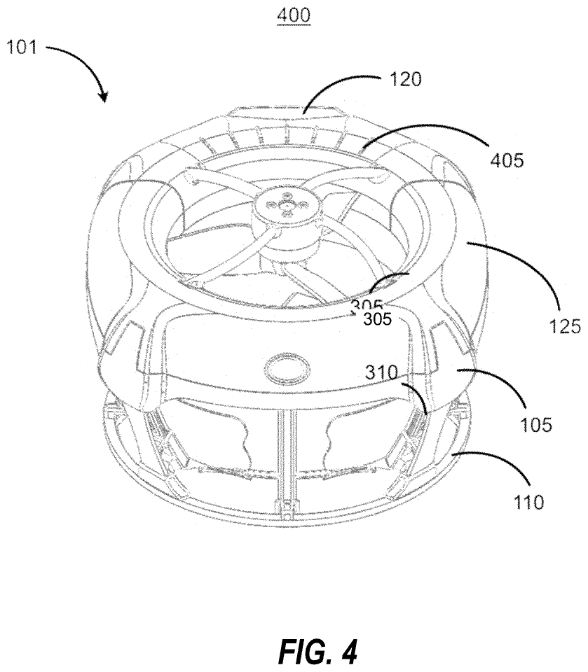

FIG. 4 is an example illustration 400 of a perspective view of the AV 101. In some cases, the AV 101 may not include a fan within the housing 120. In some other cases, the AV 101 may include at least one fan within the housing 120. The housing 120 of the AV 101 can include at least a vent 405 and possible additional vents to provide a free circulation of airflow through the housing 120. The vent 405 can include one or more openings. The vent 405 can allow for air to travel or circulate through into the housing 120, such as to cool the electrical components within the housing 120. For example, the electrical components can produce heat during operation. The vent 405 can allow some air (or wind) that would travel into the duct 135 to be passed into the housing 120 as passive cooling of the electrical component. In some cases, the vent 405 can be located within the duct 135 exposing the electronics directly to the airflow through the duct 135, drawing away the heat and cooling the electronics. In some instances, the AV 101 includes a first vent for receiving the air (e.g., from either end of the duct 135 and/or through duct 135) and a second vent so the air can pass through the inner portion of the housing containing the electrical components.

In another example, the AV 101 can perform active cooling procedure by initiating or increasing the rotation of the propeller within the duct. By increasing the rotation, more air can be pulled into the duct, where a fraction of the air may be passed through the vent 405. In this case, the vent 405 can receive more airflow as the propeller increase in RPM. Hence, the vent 405 of the housing 120 can be configured to receive airflow created by at least one propeller within the duct 135 to reduce the thermal of the one or more electrical components situated in the housing 120.

In some cases, the electrical component of the AV 101 can determine the temperature of the housing 120 (e.g., inside the housing 120 or of the electrical components). The electrical component can detect the temperature based on a temperature sensor inside the housing 120, for example. The electrical component can compare the temperature measurement of the housing 120 to a threshold stored in a memory (e.g., storage of the electrical component). If the electrical component determines that the temperature reaches or exceeds the threshold, the electrical component can determine to invoke a cooling protocol. The cooling protocol can include procedures, operations, or instructions to reduce the temperature of the housing 120. The electrical component can perform the cooling procedure without increasing the altitude of the AV 101.

In some cases, the electrical component of the AV 101 can operate while stationary. For example, the AV 101 can be positioned on a surface to collect data via one or more sensors. The operation of the electrical component can generate heat. The AV 101 can detect the temperature of at least the housing 120 or the electrical component. In response to the temperature of the housing 120 exceeding or reaching a threshold, the electrical component can initiate rotation of the propeller or increase the speed of the propeller without increasing altitude. In some cases, the electrical component can extend the flaps 155 to avoid lift-off or increase in altitude of the AV 101. In some cases, being stationary can be associated with being idle or in hibernation mode.

The cooling protocol can include increasing the rate of rotation (e.g., RPM) of the propeller to cause a reduction of the temperature of the housing 120. To maintain the altitude of the AV 101, the flaps 155 may be deployed (e.g., protruded) to maintain similar airflow expelling from the AV 101. For example, the AV 101 may be generating a thrust based on a first RPM of the propeller. Upon detecting that the temperature reaches the threshold, the electrical component can increase the RPM of the propeller and protrude all flaps 155 to the same level. Based on the combination of the RPM increase and protrusion of the flaps 155, the AV 101 can maintain the same or similar thrust generated at the first RPM. In another example, the AV 101 may not be in flight during the determination of the temperature of the housing 120 reaching the threshold. In this example, the electrical component can extend all flaps 155, thereby enclosing or trapping air from expelling from the lower end 310 of the duct 135. Accordingly, the electrical component can increase the RPM of the propeller without increasing the altitude of the AV 101.

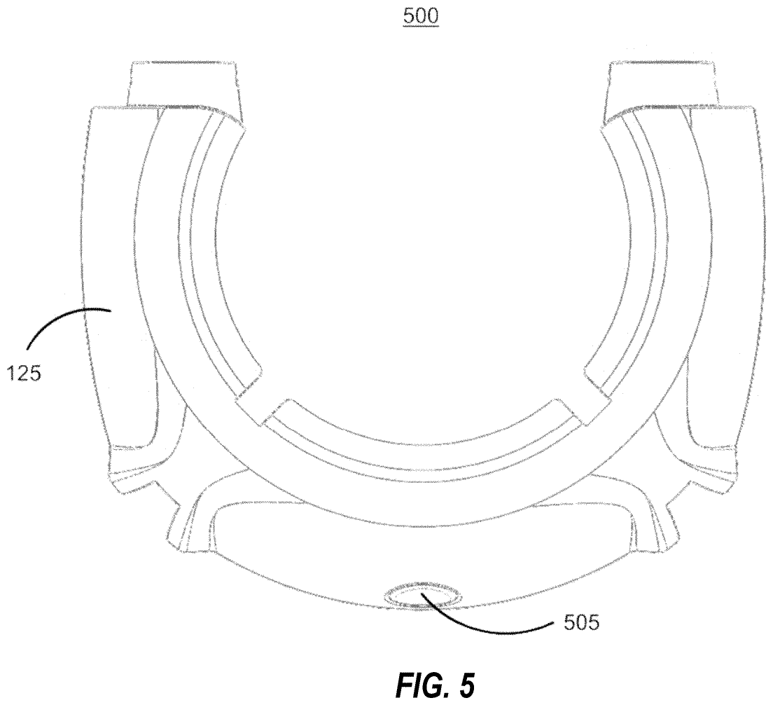

FIG. 5 is an example illustration 500 of the battery 125 of the AV 101. The battery 125 can couple to the upper portion 105 or the housing 120. The battery 125 can couple with the AV 101 via a coupling mechanism, locking mechanism, or latch mechanism, for example. The battery 125 can include a slot 505. The slot 505 can include or be installed with at least a sensor, such as a visual sensor. Accordingly, the slot 505 can provide a housing for at least one sensor to provide visual feedback data or other sensor data to a remote device. The battery 125 may also include an on/off button and/or a battery level indicator. In some cases, the slot 505 can include or be installed with a decoupling button. The decoupling button can be a part of the latching or locking mechanism of the battery 125. For example, in response to an interaction with the decoupling button, the battery 125 can disengage from at least one of the upper portion 105 or the housing 120.

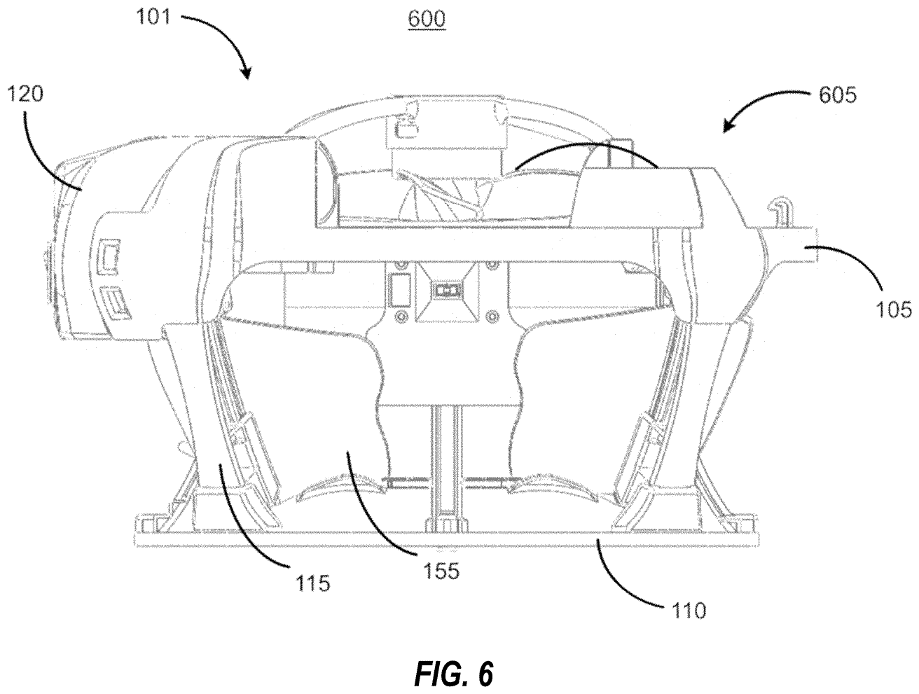

FIG. 6 is an example illustration 600 of the AV 101 without the battery 125. In this example illustration 600, the battery 125 may be detached from the upper portion 105 and the housing 120. Hence, portion 605 of the upper portion 105 is empty in this example. A battery 125 can be installed at portion 605 to form an aerodynamic upper portion of the frame structure. The battery 125 may be hooked onto a latch of the upper portion 105.

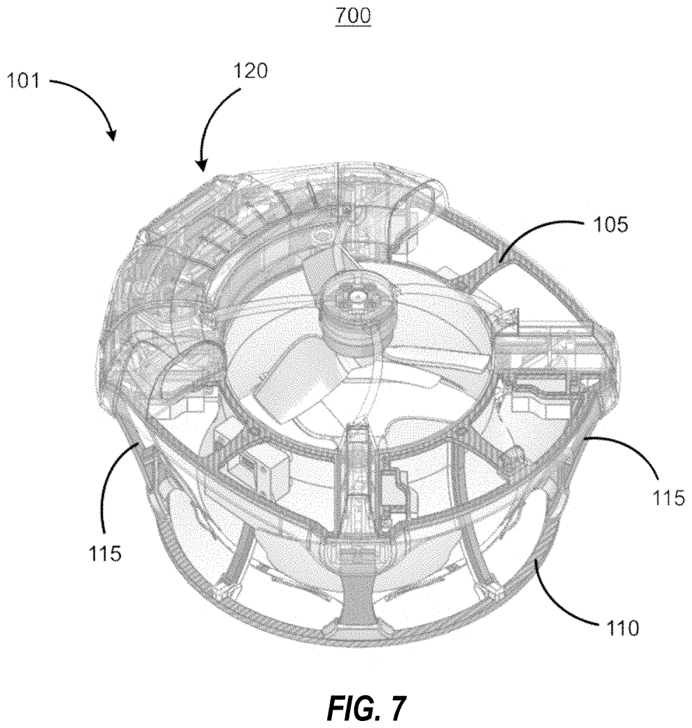

FIG. 7 is an example illustration 700 of a perspective view of the frame structure of the AV 101. In this example illustration 700, the housing 120, or other components may be transparent to illustrate the frame structure. The frame structure, including at least the upper portion 105, lower portion 110, and the bridges 115 may be composed of similar materials as other portions or components of the AV 101. In some iterations, the housing 120, the upper portion 105, lower portion 110, and the bridges 115 may be constructed in one piece. In another iteration, the housing 120 and the upper portion 105 can form the upper portion 105.

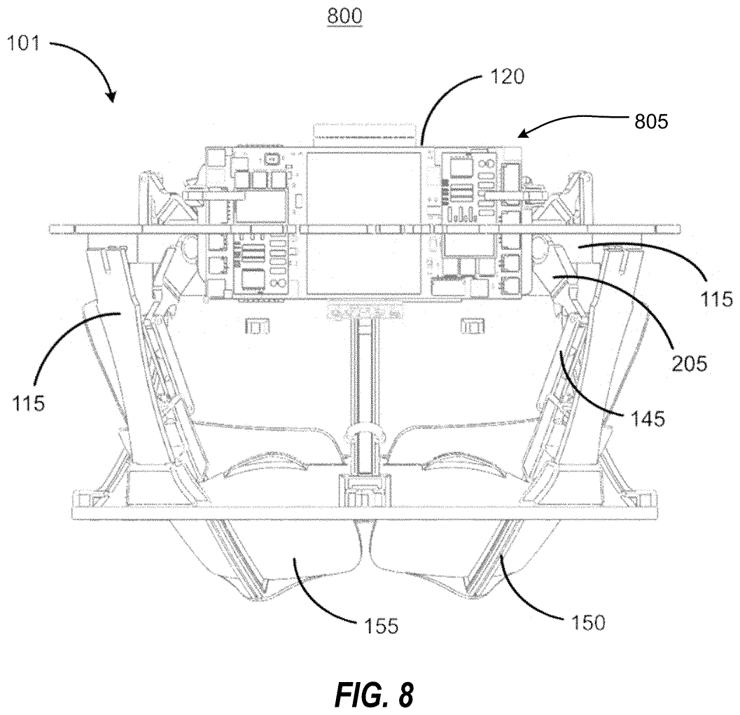

FIG. 8 is an example illustration 800 of a dissected view of the AV 101. The AV 101 can include one or more electrical components 805. The electrical component 805 can be composed of hardware, software, or a combination of hardware and software components. The electrical component 805 can send instructions to at least the motor and the actuator 315 to control the propeller and the flaps 155, respectively. The electrical component 805 can perform any control operation of the AV 101 as discussed herein.

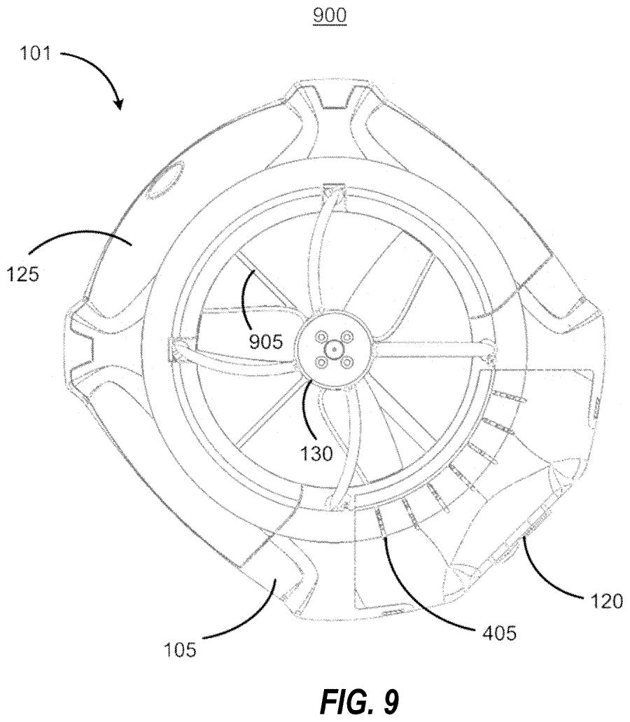

FIG. 9 is an example illustration 900 of a top view of the AV 101. As illustrated in example illustration 900, the AV 101 can include one or more mount 905 configured to mount, hold, or otherwise couple to at least one propeller. The AV 101 can include multiple mounts 905 within the duct. The mount 905 can be coupled to a motor of the propeller. The mount 905 can be coupled to or installed on the bridge 130. In some cases, the mount 905 can include one or more arms connecting to the at least one of the upper portion 105, the housing 120, the battery 125, or the duct 135 (e.g., inner wall of the duct 135) to be positioned adjacent to or at the inside of the duct 135.

FIG. 10 is an example illustration 1000 of a mechanism for driving the flaps 155. The mechanism in example illustration 1000 can refer to the linkage system. The linkage system can include at least the actuator 315 (e.g., rotary servo, stepper motor, or linear servo), an arm 205 (e.g., servo arm), and a linkage 145 (e.g., a second arm or an extension). In some cases, the actuator 315 can refer to the linkage system, such that the linkage system includes the servo, the arm 205, and the linkage 145 to drive the flap 155. Each part of the linkage system can couple to the flap 155 at the spine 150 of the flap 155. The movement of the spine 150 and the flap 155 can be predetermined based on the guide 140 (e.g., guide rail). The linkage system can include any additional links or joints to drive the flap 155. For example, the arm 205 can be a first joint and the linkage 145 can be a second joint. In some cases, the linkage 145 can be coupled to a third joint, where the third joint couples to the spine 150 to drive the flap 155. Hence, the linkage system can include a sequence of joint connections to increase the range of the extension or retraction and provide a compact retractable design for the flaps 155. In some cases, the actuator 315 can be embedded to, installed on, or coupled to the duct 135 (e.g., outer wall of the duct 135), the guide 140, the bridge 115, or other portions of the frame structure.

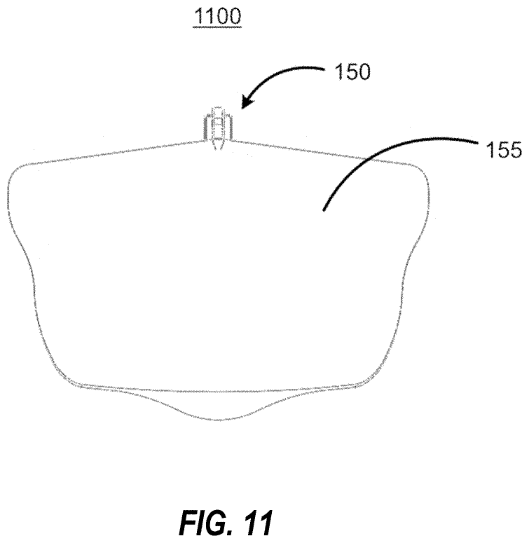

FIG. 11 is an example illustration 1100 of a flap 155 of the AV 101. The flap 155 can be embedded, installed, or inserted in the AV 101. The flap 155 can be curved in any axes, such as vertically, horizontally, orthogonally, etc. (e.g., curved along at least one of x-axis, y-axis, or z-axis). In some cases, the flap 155 can be flat, linear, or non-curved. The flap 155 can be of any shape configured to protrude, retract, or otherwise position side the frame structure of the AV 101. The flap 155 can include a spine 150, which can be a part of the flap 155. In some cases, the spine 150 can be a separate component, such that the flap 155 can be removed from the spine 150. The flap 155 can be configured to redirect airflow from the duct. The flap 155 may be composed of flexible material. In some cases, the flap 155 may be composed of rigid material. In some cases, the flap 155 can be composed of a material similar to the spine 150. The flap 155 can include any thickness, such as 1 mm, 3 mm, 5 mm, among others.

In some instances, the spine 150 can extend from the top of the flap 155 to the bottom of the flap 155. In some cases, the spine 150 can extend intermittently along a substantial portion of the flap 155. In some other cases, the spine 150 may extend along a portion (e.g., 10%, 30%, 50% in height or length, etc.) of the flap 155.

In some cases, the spine 150 (e.g., the curvature of the spine 150) can represent the curvature of the flaps 155. The spine 150 can represent or indicate the angle of inclination towards the duct 135. The spine 150 can indicate when the flap 155 protrudes (or retracts) linearly, non-linearly, or angled towards or away from the lower end of the duct 135, for example. For example, features (e.g., curvature, dimension, length, etc.) of the spine 150, the guide 140, or the flap 155 can indicate the relationship between the flap protrusion compared to control of the AV 101. For example, the controller can increase control of the AV 101 by increasing the protrusion of one or more flaps 155. The controller can decrease control of the AV 101 by decreasing the protrusion (or increasing the retraction) of the one or more flaps 155. In some cases, the extent of protrusion of the one or more flaps 155 can indicate the amount of control. For instance, 10% protrusion can provide 10% control, 30% protrusion can provide 30% control of the AV 101, etc. In another example, 10% protrusion can provide 5% control, 30% protrusion can provide 40% control, and 50% protrusion can provide 70% control based on at least the curvature of the flap 155, the guide 140, or the spine 150. The control of the AV 101 can refer to or include, for example, the capture of airflow from the duct (e.g., for each flap), the ability to change the flight path, or the amount of airflow that will be redirected. The curvature or flare of the duct 135 can facilitate airflow to be captured at the flap 155.

In some cases, the AV 101 can provide more control at the lower insertion of the flap 155 or less control at the lower insertion of the flap 155. For example, the spine 150 or shape of the flap 155 can be designed or constructed such that the flap 155 can be angled more inward towards the center of the duct 135 at lower insertion to provide more control at lower insertion. In another example, the spine 150 can be constructed such that the flap 155 can be angled less towards the center of the duct 135 at lower insertion to provide less control at lower insertion. The spine 150, the guide 140, or the flap 155 of the AV 101 can be constructed with any angle or curvature at any position along the extension of the spine 150. In further example, the flap 155 can be curved to redirect more of the incoming airflow towards a predetermined direction. In some cases, higher curvature of the flap 155 can increase redirection of the airflow, thereby providing more control. In some other cases, less curvature of the flap 155 (e.g., flat or linear flap 155) may provide less control, which may be used in certain portions of the flap. For instance, the flap 155 can be curved at the lower edge of the flap 155 and flat near the upper edge of the flap 155. Accordingly, the AV 101 can provide varying control at different extensions or insertions of the flap 155.

In some cases, the spine 150 may be a part of the flap 155. In some other cases, the flap 155 may not include a spine 150. For example, the flap 155 can be an extension of the linkage 145 or arm 205. In another example, the flap 155 can include an index, ridge, or channel as part of the flap 155 configured to couple with or slide along the guide 140. In some cases, the flap 155 can be of the linkage system, such that the arm 205, the linkage 145, and the flap 155 may be a component of the linkage system. In some cases, the flap 155 can include one or more filleted notches on the sides of the flap 155. For example, the fillet notches can assist in clearing, passing, or transitioning through one or more components mounted adjacent to the lower end 310 of the duct 135 (e.g., bottom motor mount) or near the lower portion 110. In another example, the fillet notches can facilitate in the extension of the flaps 155 to cover a significant portion of the outlet of the duct 135.

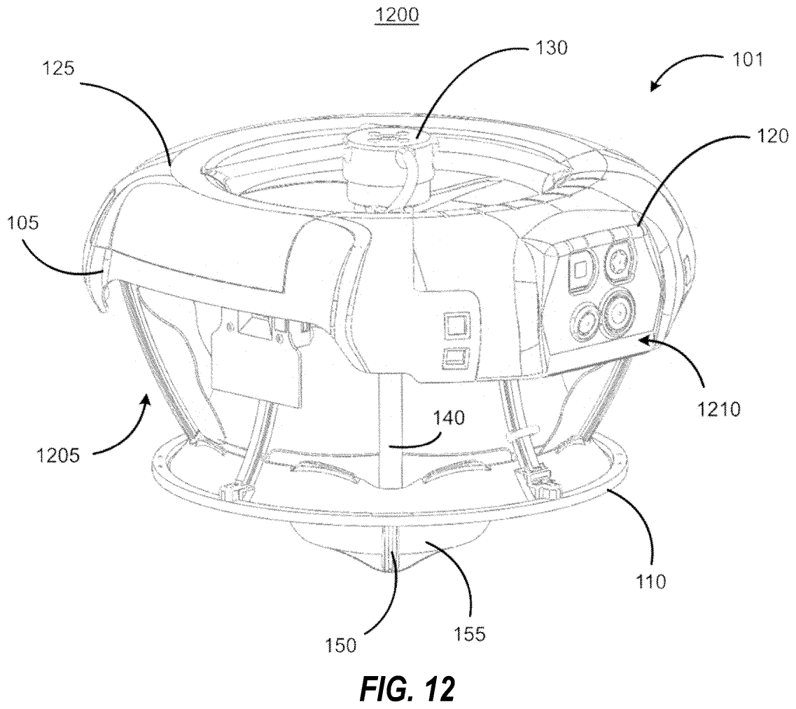

FIG. 12 is an example illustration 1200 of the AV 101 with the guides 140 as bridges 115. The frame structure of the AV 101 can include an upper portion 105 and a lower portion 110 connected via an intermediary component. The intermediary component can be bridges 115 (e.g., one bridge 115, two bridges 115, three bridges 115, four bridges 115, five bridges 115, etc.). The bridges 115 can be evenly spaced around a perimeter of the AV 101. In some cases, the AV 101 may not include bridges 115. For example, the AV 101 can be constructed or implemented with open bridges 1205 (e.g., cut-off bridges or unconnected bridges). In this example, the guide 140 can be an intermediary component connecting the upper portion 105 to the lower portion 110. For example, the guide 140 can extend from the upper portion 105 to the lower portion 110. The guide 140 can assist the flap 155 for protruding or retracting in the frame structure. In some cases, the guide 140 can form the bridge 115.

The AV 101 can include a housing 120 having various components 1210. The various components 1210 can be embedded into or protrude from the housing 120. For example, the housing 120 can include one or more sensors or ports. The ports can be an outlet, charging ports, LED lights, or an interface for wired connection to an external device, for example. The sensor can include any sensors, such as an infrared sensor, a camera, among others. In some cases, the upper portion 105 can include or hold an enclosure, such as to encapsulate the electrical component 805.

In some cases, the AV 101 can include a cooling slot or opening as part of the components 1210. For example, the cooling slot can include a fan to pull air into the housing 120. In some cases, the cooling slot can be a socket or an opening near the vent 405 (e.g., inside the duct 135) to facilitate airflow into the housing 120 or to the electrical component 805. In some other cases, the duct 135 may not include a slot, socket, or opening.

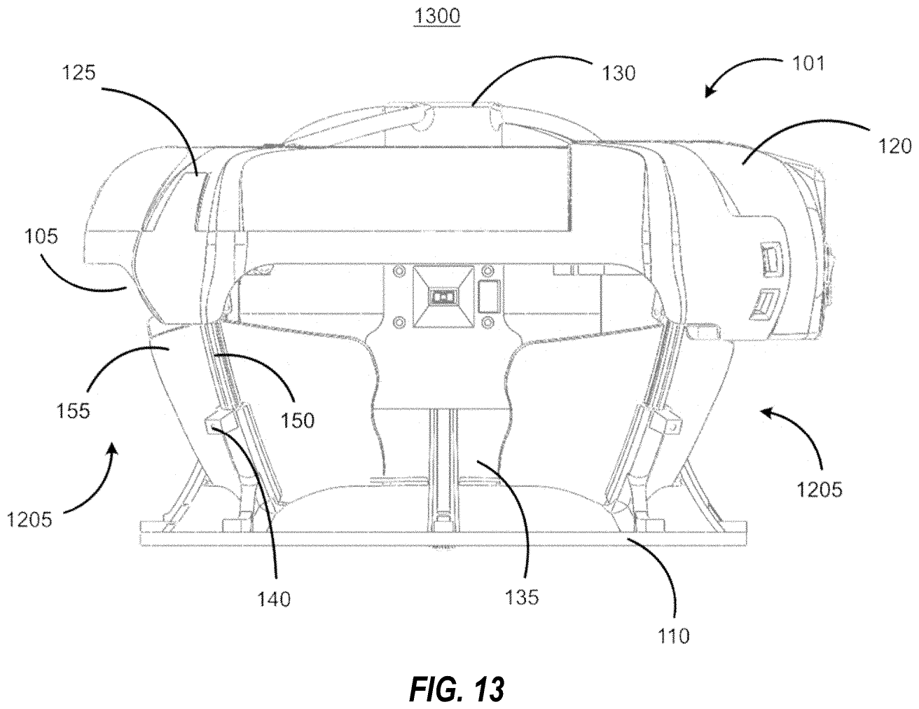

FIG. 13 is an example illustration 1300 of the AV 101 with the duct 135 as a bridge 115. The frame structure of the AV 101 may not include the bridges 115. For example, the duct 135 of the AV 101 can be an intermediary component connecting the upper portion 105 to the lower portion 110. The duct 135 can extend from the upper portion 105 to the lower portion 110 to provide a connection between the frames, thereby establishing the frame structure. The guide 140 can couple or connect to the lower portion 110. Hence, the AV 101 can include an open bridge 1205, for example.

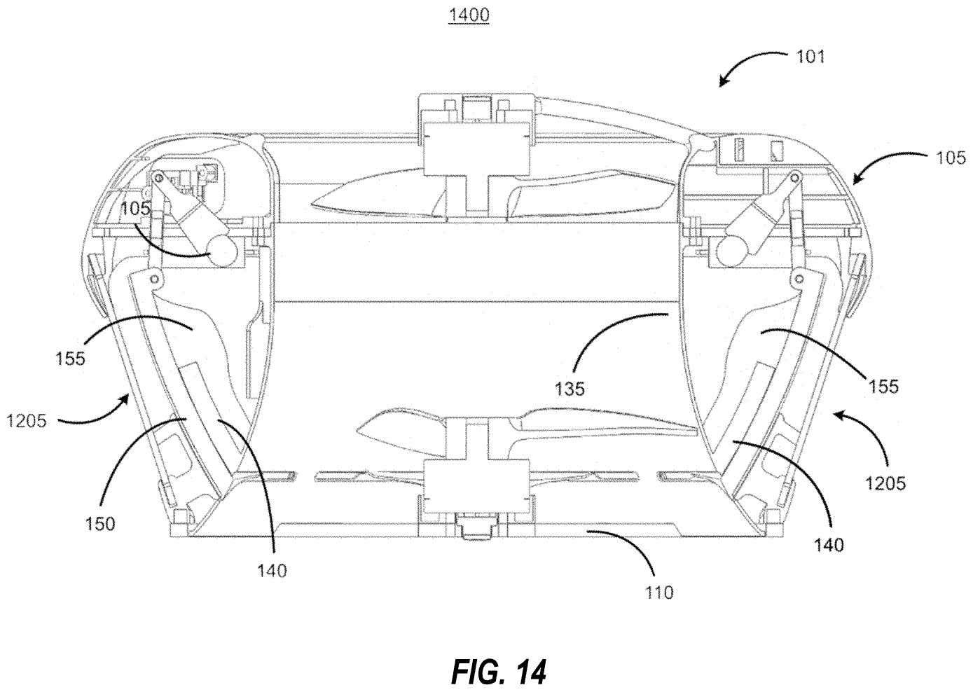

FIG. 14 is an example illustration 1400 of the AV 101 with guides 140 on the side of the duct 135. The AV 101 can include an open bridge 1205 construction or include bridges 115 connecting the upper portion 105 to the lower portion 110. The AV 101 can include a guide 140 attached, coupled, or otherwise embedded to the side of the duct 135. The side of the duct 135 can refer to the outer wall of the duct 135. The spine 150 of the flap 155 can be positioned on the inner side of the flap 155. For instance, the spine 150 can be coupled to the inner side of the flap 155 configured to receive the airflow from the duct 135. The spine 150 can extend from the top of the flap 155 to the bottom of the flap 155. In some cases, the spine 150 can extend along a substantial portion of the flap 155. In some other cases, the spine 150 may extend along one or more portions (e.g., 10%, 30%, 50% in height or length, etc.) of the flap 155.

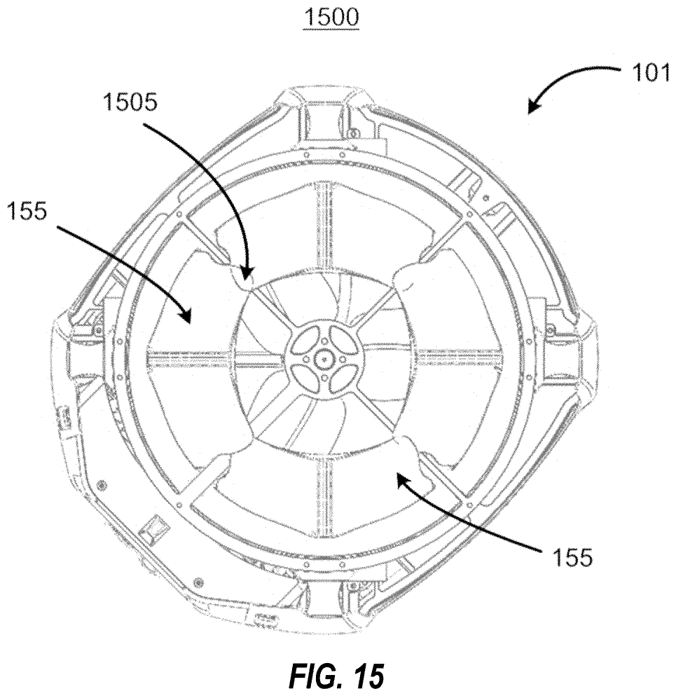

FIG. 15 is an example illustration 1500 of overlapping flaps 155 of the AV 101. The illustration 1500 can illustrate the flaps 155 protruding from the frame structure. The flaps 155 can overlap at least at point 1505. In some cases, the flap 155 can be constructed with a flexible material(s). In some other cases, the flap 155 can be constructed with a rigid material(s). The spines 150 of the flaps 155 may not be symmetrical to one another. For example, a first flap 155 can curve inward towards the lower end 310 of the duct 135 more than a second flap 155 (e.g., based on the construction of the spine 150 of each of the flaps 155) or the flaps 155 can be offset vertically (e.g., shifted vertically, such that a first flap 155 can protrude at a different height or position from a second flap 155). Hence, the flaps 155 can overlap with rigid materials, for example. The controller of the AV 101 can take into consideration each of the configuration of each component of the AV 101 to perform a predetermined function.

In some cases, the flaps 155 may not overlap. For example, one or more flaps 155 can extend to cover a substantial area of the outlet of the duct 135. The outlet of the duct 135 can refer to the opening at the lower end 310 of the duct 135. The outlet can expel airflow from the duct 135 to the extended one or more flaps 155 to redirect the airflow. The flaps 155 may overlap more as the flaps 155 are extended to their maximum extension. Each of the flaps 155 can cover a substantial portion of the outlet of the duct. For example, the flaps 155 can cover at least 50% of the outlet, or between 25%-75% of the outlet.

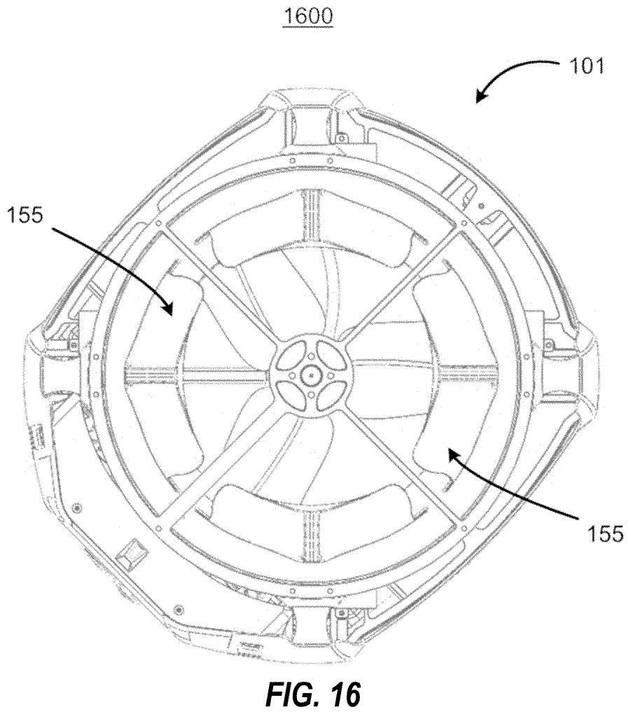

FIG. 16 is an example illustration 1600 of partially inserted flaps 155 of the AV 101. The flaps 155 may not overlap at a predetermined extension or insertion. For example, the AV 101 may be configured, such that the flaps 155 overlaps at 50% extension. In this example, the flaps 155 can protrude from the frame structure without overlapping until reaching the 50% point of extension. The AV 101 may be configured such that the flaps 155 overlaps at other points of extension. In some cases, each pair of adjacent flaps 155 may overlap at different protrusion points. For example, a first pair of flaps 155 can overlap at 40% extension, a second pair of flaps 155 can overlap at 43% extension, etc. In some cases, the AV 101 may provide non-overlapping flaps 155, covering a substantial portion of the outlet of the duct 135 when protruded.

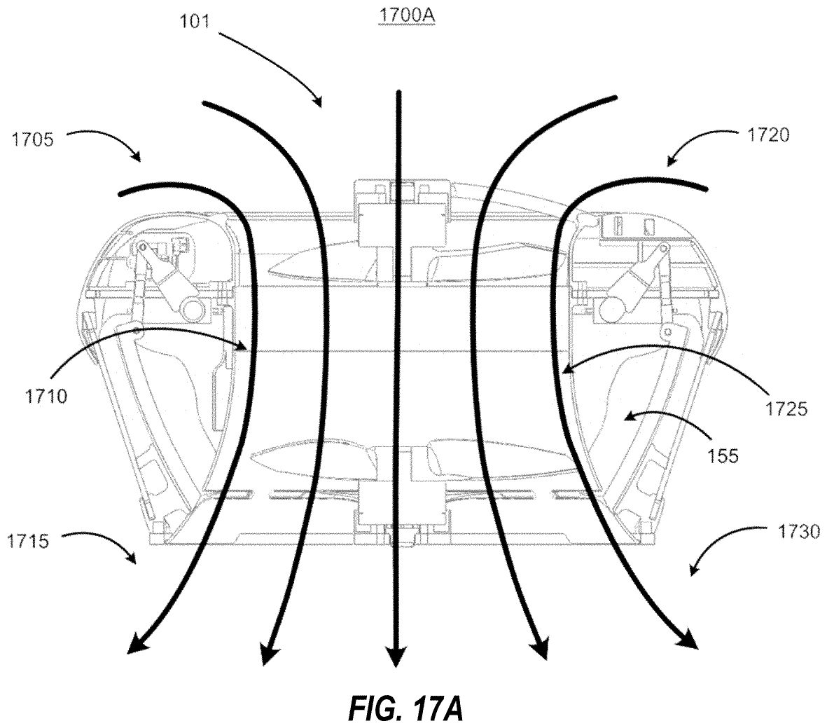

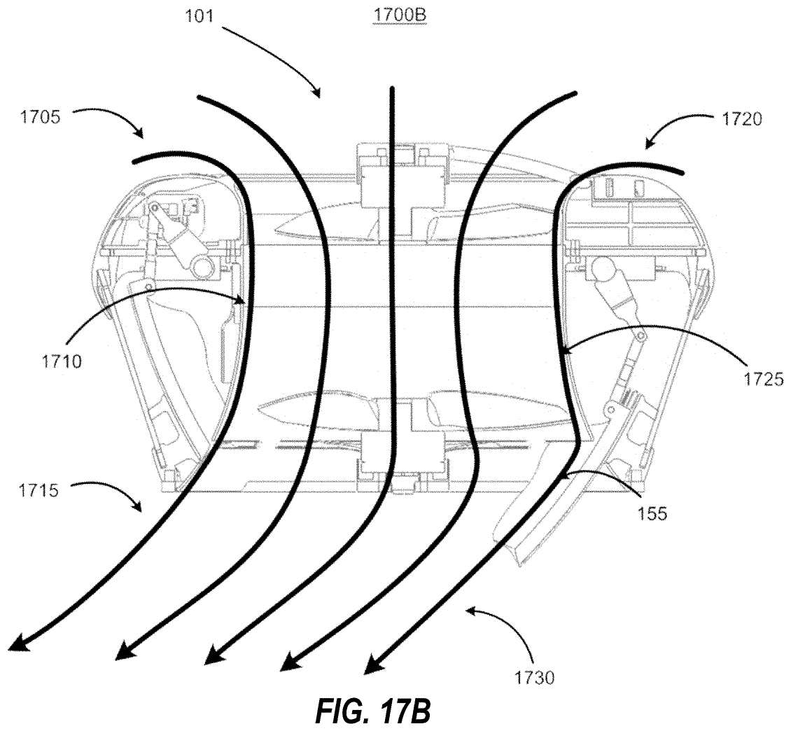

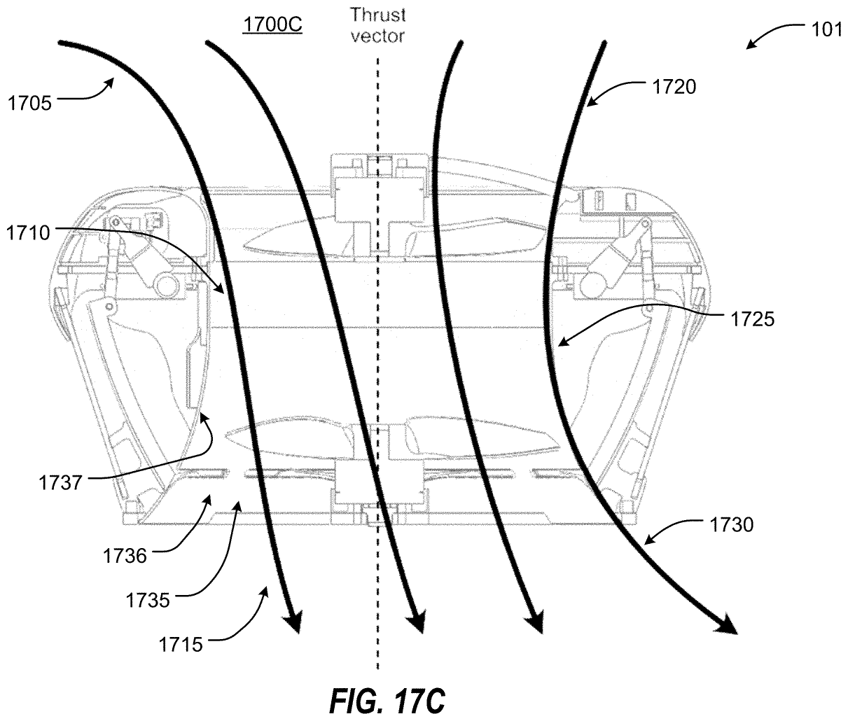

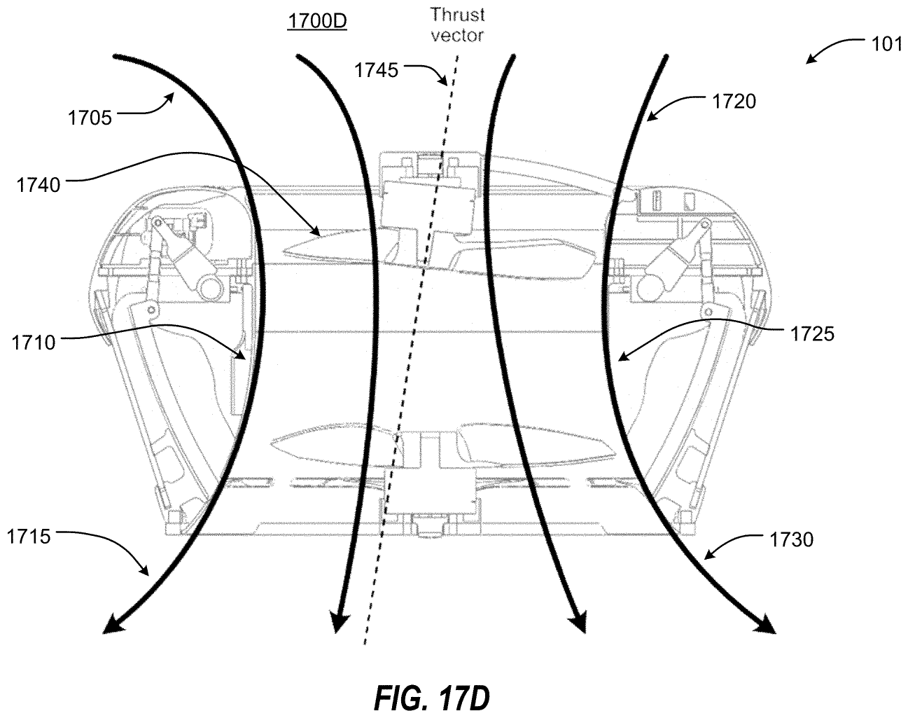

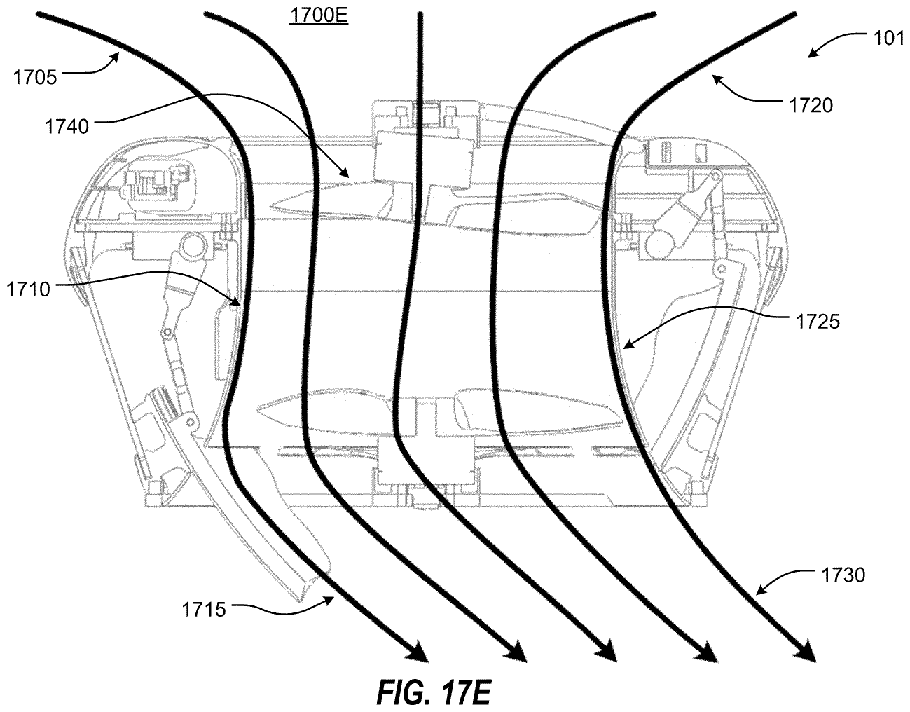

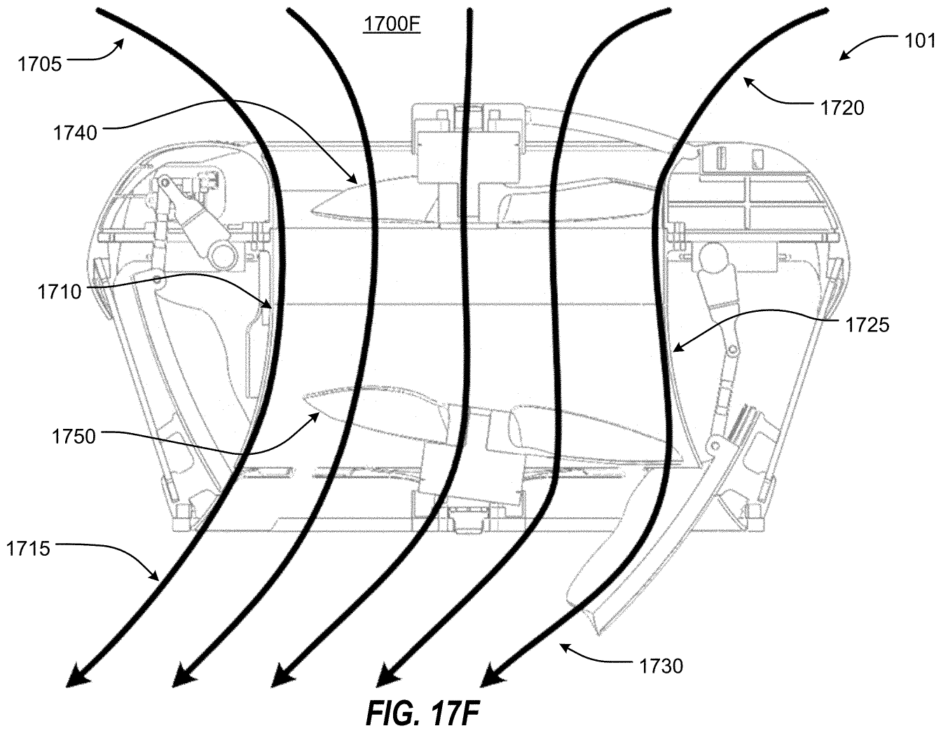

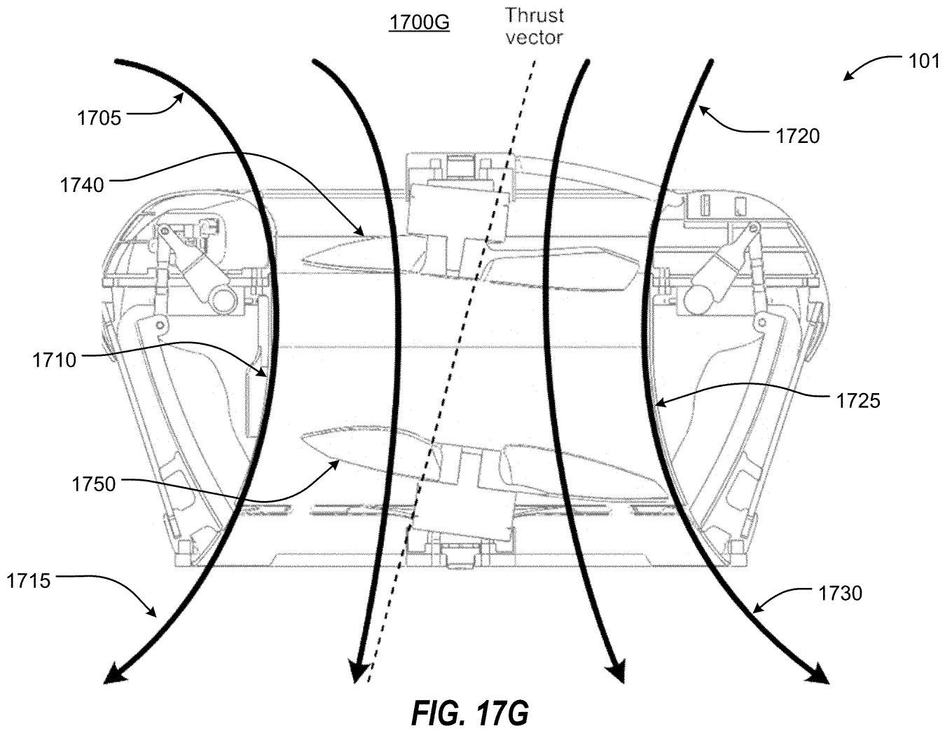

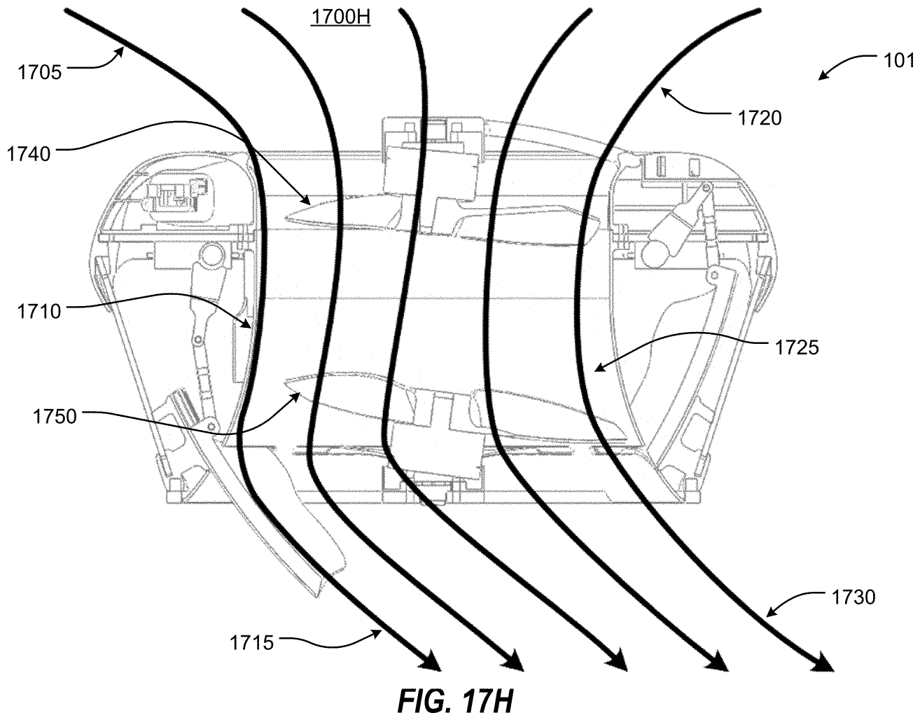

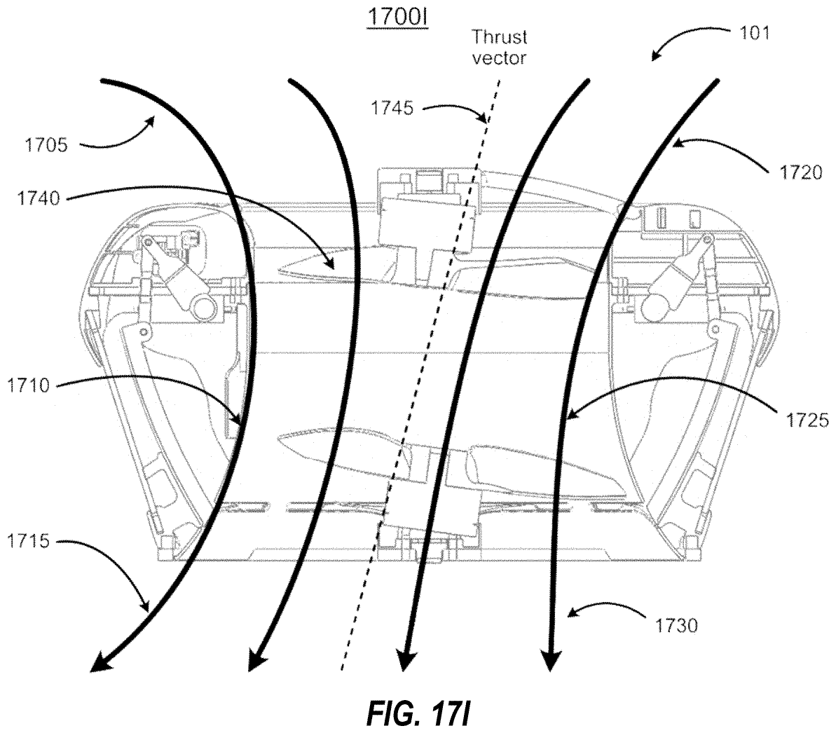

FIG. 17A is an example illustration 1700A of an airflow path. The airflow path can be defined by the various components of the AV 101, such as the duct 135, which can extend to the top portion 105 and/or a top of the housing 120. The airflow path can be represented by one or more vectors. The propeller can pull air into the duct 135 via the inlet of the duct 135. For example, a first vector (or a first airflow path) can include at least a first portion 1705, a second portion 1710, and a third portion 1715. At the first portion 1705, the air can travel into the duct 135 via the inlet of the duct 135. At the second portion 1710, the airflow can traverse along the inner wall of the duct 135 (e.g., gliding or following the curvature of the flared duct 135). At the third portion 1715, the airflow can exit or propel from the lower portion 110 at an angle represented or guided by the curvature of the duct 135. For instance, at the third portion 1715, the airflow can be directed away from the center of the duct 135 based on the curvature of one or more surfaces of the duct 135.

Illustration 1700A can include a second vector having at least a first portion 1720, a second portion 1725, and a third portion 1730. In this example, the second vector or the one or more portions (e.g., first portion 1720, second portion 1725, or third portion 1730) can exhibit or follow a similar path as the one or more portions of the first vector. For example, at the first portion 1720, the air can travel into the duct 135. At the second portion 1725, the air can traverse along the inner wall of the duct 135. At the third portion 1730, the airflow can exit from the lower portion 110 or the AV 101 at similar angle as the third portion 1715 (e.g., away from the center of the duct).

FIG. 17B is an example illustration 1700B of an airflow path when a flap 155 is protruded. In some cases, the illustration 1700B can depict an airflow path when at least one flap 155 is inserted. The airflow path from the AV 101 can include or correspond to a thrust vector. The airflow can be generated by the propeller inside the duct 135. The airflow path can be represented by one or more vectors. The propeller can pull air into the duct 135 via the inlet of the duct 135. For example, a first vector (or a first airflow path) can include at least a first portion 1705, a second portion 1710, and a third portion 1715. At the first portion 1705, the air can travel into the duct 135 via the inlet of the duct 135. At the second portion 1710, the airflow can traverse along the inner wall of the duct 135 (e.g., gliding or following the curvature of the flared duct 135). At the third portion 1715, the airflow can exit or propel from the lower portion 110 further away from the center of the duct than in FIG. 17A which can be caused by the protrusion of the opposite flap 155. For instance, the airflow at portion 1730 that is directed by at least one protruding flap 155 can direct the airflow at portion 1715 (e.g., at the opposite side of the AV 101 from the protruding flap 155) further away from the center of the duct 135 as compared to portion 1715 of FIG. 17A. Portion 1715 of the thrust vector can be redirected further away from the center of the duct at a degree corresponding to the protrusion length of the flap 155 or an amount of protrusion of the flap 155, the curvature of the flap 155, the curvature of the duct 135, or the angle of incidence (e.g., similar to angle 320) between the inner surface of the flap 155 and the lower end 310 or the center of the duct 135.

In some examples, the airflow at portion 1730 path can be directed further away from or toward the center of the duct 135 by changes in propeller positioning, for instance, using a tiltrotor or swash plate. An axis of rotation of the propellers can be moved off-center from a vertical axis of the duct 135 thus changing the direction of the different airflow portions (1720, 1730, 1705, 1715, etc.) and resulting in pitch or roll changes for the AV 101. Additionally or alternatively, the air flow entering and exiting the duct 135 can be changed or redirected by tilts in the rotors of the propellers themselves (e.g., using a swash plate or other methods such as pulse modulation techniques of the motors for cyclical and collective control). For instance, tilting the rotors can shift the airflow portions 1720, 1730, 1705, and/or 1715 closer to the vertical axis and/or further from the vertical axis to increase or decrease an amount of air pulled through the duct 135 along certain portions of the inner surface of the duct 135, causing roll or pitch changes. Accordingly, control of the AV 101 can be increased by redirecting the airflow exiting the duct 135 (e.g., along an inner surface of the duct 135) using various techniques for positioning the propellors and/or positioning the flap 155 (e.g., cyclical blade control and/or collective blade control).

In another example, a second vector (or a second airflow path) can include at least a first portion 1720, a second portion 1725, and a third portion 1730 of the airflow. At the first portion 1720, the airflow can traverse into the duct 135 via the inlet. At the second portion 1725, the airflow can traverse along the inner wall of the flared-out duct 135. At the third portion 1730, the airflow can be directed by a protruding flap 155. The protruding flap 155 can change at least the direction and angle of the airflow. The direction and angle of the airflow can be based on, for instance, the protrusion length of the flap 155, the curvature of the flap 155, or the angle of incidence (e.g., similar to angle 320) between the inner surface of the flap 155 and the lower end 310 or the center of the duct 135. The controller of the AV 101 can adjust the protrusion level (e.g., corresponding to the angle of incidence) of the flap 155 to increase the control moment.

FIGS. 17C-17I illustrate various examples of flap configurations, propellor configurations, and combinations thereof, to control the airflow pathway for the air travelling through the duct 135 which, in turn, controls a thrust vector of the AV 101 and/or provides navigational control of the AV 101. Any of the flap and/or propellor operations, configurations, or arrangements disclosed below (e.g., and throughout this disclosure) can be used in combination and/or in sequence to perform various navigational movements.

For instance, FIG. 17C is an example illustration 1700C of the AV 101 including a flow separation 1735 induced by crosswinds or forward travel. Lower area 1736 shows an area adjacent to a duct wall 1737 that is experiencing flow separation 1735, for instance, at the third portion 1715 of the first air flow vector exiting the duct 135. FIG. 17D is an example illustration 1700D of the AV 101 including upper propeller 1740 with its blades pitched away from the vertical axis to produce a vectored thrust 1745 countering the flow separation 1735. The flow diagram of FIG. 17D illustrates the airflow path through the duct 135 when the upper propeller 1340 is tilted. Portion 1715 of the first airflow vector shows a decreased flow separation. FIG. 17E is an example illustration 1700E of the AV 101 including the top propeller blade 1740 being pitched in such a way to redirect the airflow towards a protruded flap 155. FIG. 17F is an example illustration 1700F of the AV 101 including a bottom propeller 1750 of the one or more propellers with a blade pitch (e.g., being pitched) in such a way to redirect the airflow away from a protruded flap 155. FIG. 17G is an example illustration of the AV 101 having both the top propeller 1740 and the bottom propeller 1750 tilted to produce a thrust vector to counter the same flow separation 1735 depicted in FIG. 17C, and/or to cause a velocity of the AV 101. FIG. 17H is an example illustration 1700H of the AV 101 having both the top propeller 1740 and the bottom propeller 1750 tilted and redirecting the airflow towards a protruded flap 1750 (e.g., to increase or decrease a magnitude of a thrust vector). FIG. 17I is an example illustration 17001 of the AV 101 having top and bottom propeller blades tilted to increase at least one of the lateral or vertical velocities of the AV 101. The configuration shown in example illustration 17001 can control the AV without using the flaps 115 and/or in scenarios omitting a crosswind.

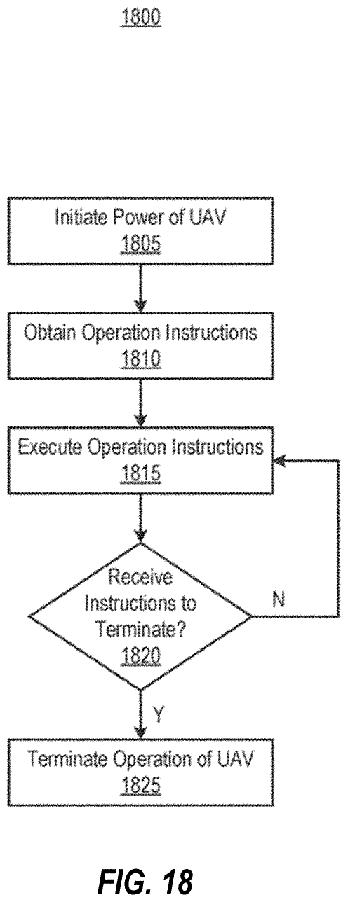

FIG. 18 is a flow diagram of an example method 1800 of operating the AV. The method 1800 can be performed by the AV (e.g., AV 101), e.g., the one or more electrical components of the AV 101, or one or more components thereof, such as in conjunction with at least FIGS. 1-18. In brief overview, at step 1805, the AV can initiate power. At step 1810, the AV can obtain operation instructions. At step 1815, the AV can execute the operation instructions. At step 1820, the AV can determine whether instructions to terminate are received. At step 1825, the AV can terminate operations.

Still referring to FIG. 18, and in further detail, the AV can initiate a power or a start-up process, at step 1805. The AV can initiate power in response or upon receiving a power-on trigger or command. The AV can include a button to power the AV. A user can press the button the power the AV. In some cases, the AV can receive a command from a remote device to turn on the AV (e.g., exit hibernation or sleep mode). In this case, the AV may be constantly listening for a command from the remote device.

At step 1810, the AV can obtain operation instructions. The operation instructions can be preconfigured, pre-installed, or pre-stored in the memory of the AV. The memory or storage can be a part of the electrical component of the AV. The AV can receive instructions from the remote device. The operation instructions can include functions to increase the altitude of the AV 101, change the direction of the AV, move the AV in a predetermined direction, among others. The operation instructions can include an indication of an RPM corresponding to a predetermined altitude. The operation instructions can indicate how much to extend the flaps to drive the AV in a certain direction, and the velocity towards the direction. The operation instructions can include an algorithm taking into account factors affecting certain performances of the AV, such as altitude affected by flap protrusions, wind speed, or humidity, for example. The AV can utilize the operation instructions to perform features or functionalities as discussed hereinabove for controlling the AV.

At step 1815, the AV can execute the operation instructions. The AV can receive a command from a remote device to execute at least one of the operations, which can be pre-configured in the memory. For example, the AV can receive a command to move in a direction at a predetermined altitude. Accordingly, based on the operation instructions, the AV can protrude the flaps and increase or decrease the RPM of the propellers accordingly. In some cases, the AV can receive a command to perform autonomous surveillance actions in an area. In this case, the AV can receive, retrieve, or obtain a map of the area. The AV can execute the operation instructions (e.g., autonomous operations) to navigate within the area. The AV can follow a path indicated by the user. In some other cases, the AV can execute a general surveillance operation, such as scanning all accessible portions within the specified area, for example. In another example, the AV can execute the operations including adjusting the rate of rotation of the propeller, determining which of the flaps to protrude based on the direction to move in, and extend the respective flap(s) to move in the predetermined direction at a certain velocity.

Upon completing the execution of the operation instructions, the AV can be idled. In some cases, the AV can repeat the operation instructions previously completed based on instructions from the remote device. In some cases, the AV can sleep after completing the execution of the operating instructions. In some cases, the AV may sleep or initiate a termination instruction upon a timer expiration.

At step 1820, the AV can determine whether instructions to terminate are received. The AV can determine the expiration of the timer or receive a trigger to terminate the AV operation. If the termination instructions are not received, the AV can continue executing the operation instructions (e.g., back to step 1815). Upon receiving instructions to terminate or the expiration of the timer, the AV can proceed to step 1825.

At step 1825, the AV can terminate operations. To terminate operations, if the AV is in flight, the AV may lower the altitude to a floor or an object. In some cases, the AV can identify a dock station or platform to land on. In response to landing on a surface, the AV can sleep or power off accordingly. In some cases, the AV can terminate operation upon detecting an error (e.g., software or hardware error). In this case, the AV can transmit a notification to the remote device and proceed to execute the termination operation (e.g., exit operation or procedure).

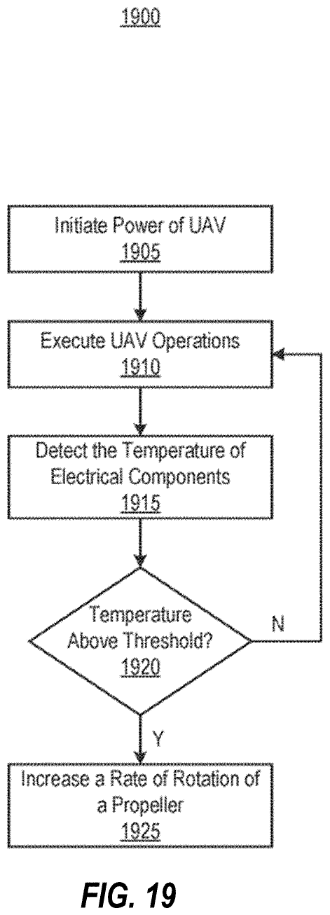

FIG. 19 is a flow diagram of an example method 1900 of reducing thermal of the AV. The method 1900 can be performed by the AV 101, e.g., the one or more electrical components of the AV 101, or one or more components thereof, such as in conjunction with at least FIGS. 1-17. The method 1900 can include one or more steps or procedures from at least method 1800 in conjunction with FIG. 18. The method 1900 can include the AV initiating power, at step 1905. At step 1910, the AV can execute operations. At step 1915, the AV can detect the temperature of one or more electrical components. At step 1920, the AV can identify whether the temperature is above a threshold. At step 1925, the AV can determine to increase the rate of rotation of the propeller.

Still referring to FIG. 19, and in further detail, the AV can initiate power, at step 1905. The AV can initiate power upon receiving instructions or commands from a remote device. In some cases, the AV can initiate power in response to a trigger, such as a power button press. The AV can initiate power similar to step 1805. At step 1910, the AV can execute operations, such as similar to step 1815, in response to receiving or obtaining the operation instructions.

At step 1915, the AV can detect the temperature of one or more electrical components. The AV can determine the temperature of the electrical component before flight, during flight, or after landing. The AV can detect the temperature of the electrical component using a temperature sensor. The AV can detect the temperature of the housing of the electrical component. The AV can compare the temperature of at least the housing or the electrical component to a threshold.

At step 1920, the AV can identify whether the temperature of the housing or the electrical component is above a threshold (e.g., acceptability threshold for temperature). The threshold may be different or similar for the housing or the electrical component. If the temperature does not reach the threshold, the AV can proceed to step 1910 to continue any remaining operation. If the temperature reaches or is above the threshold, the AV can proceed to step 1925 to begin a cooling protocol.

At step 1925, the AV can determine to increase the rate of rotation of the propeller. The increase of the rate of rotation of the propeller (e.g., increase RPM) can be a part of the cooling protocol. In some cases, the AV may perform the cooling protocol during flight, while stationary, or at the ground. The AV can increase the rate of rotation of the propeller to increase airflow into the vent of the housing. The increased airflow can cool the electrical component within the housing. In some cases, the AV can determine a rotation threshold for when the AV will take flight or increase altitude. In this case, the AV may increase the rotation above the threshold upon extending all flaps to reduce thrust generated by the propeller via the duct. By reducing thrust, which was increased by the increase in RPM, the AV can maintain the altitude (e.g., on the floor or in-flight) while cooling the electrical components or other internal components of the AV.

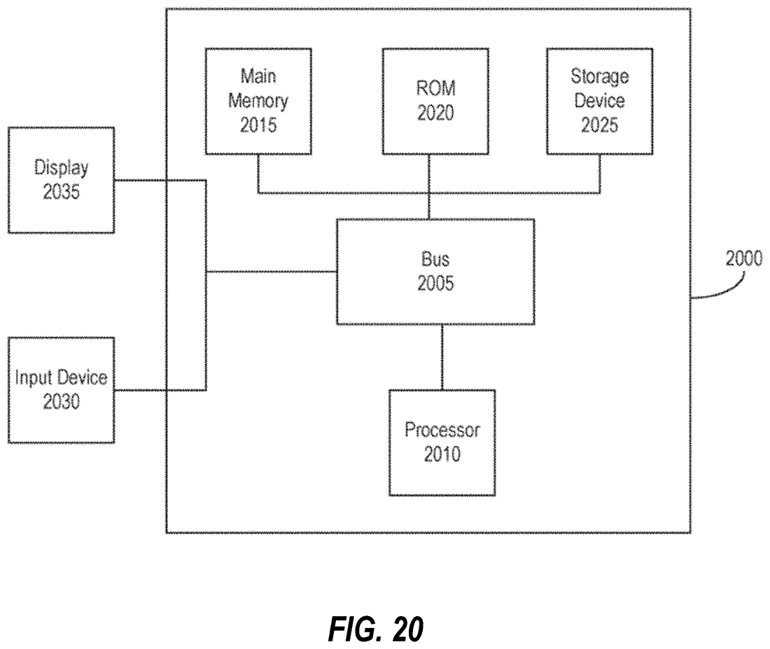

FIG. 20 is a block diagram of an example computer system 2000. The computer system or computing device 2000 can include or be used to implement one or more components of the AV (e.g., AV 101 illustrated in at least illustrations 100, 200, 300, 400, 600, 700, 800, etc.) or perform one or more aspect of the methods 1800 or 1900. For example, the system 2000 can implement one or more components or functionalities of the AV or the electrical components of the AV. The computing system 2000 includes at least one bus 2005 or other communication components for communicating information and at least one processor 2010 or processing circuit coupled to the bus 2005 for processing information. The computing system 2000 can also include one or more processors 2010 or processing circuits coupled to the bus for processing information. The computing system 2000 also includes at least one main memory 2015, such as a random access memory (RAM) or other dynamic storage devices, coupled to the bus 2005 for storing information, and instructions to be executed by the processor 2010. The main memory 2015. The main memory 2015 can also be used for storing one or more of a flight control program, collected data, diagnostic program, data processing program, or other information. The computing system 2000 may include at least one read only memory (ROM) 2020 or other static storage device coupled to the bus 2005 for storing static information and instructions for the processor 2010. A storage device 2025, such as a solid state device, magnetic disk or optical disk, can be coupled to the bus 2005 to persistently store information and instructions.

The computing system 2000 may be coupled via the bus 2005 to a display 2035, such as a liquid crystal display, or active matrix display, for displaying information to a user. An input device 2030, such as a keyboard or voice interface may be coupled to the bus 2005 for communicating information and commands to the processor 2010. The input device 2030 can include a touch screen display 2035. The input device 2030 can also include a cursor control, such as a mouse, a trackball, or cursor direction keys, for communicating direction information and command selections to the processor 2010 and for controlling cursor movement on the display 2035. In some cases, the display 2035 can, for example, be part of the AV, electrical components, or other components depicted herein.

The processes, systems, and methods described herein can be implemented by the computing system 2000 in response to the processor 2010 executing an arrangement of instructions contained in main memory 2015 (e.g., non-transitory instructions). Such instructions can be read into main memory 2015 from another computer-readable medium, such as the storage device 2025. Execution of the arrangement of instructions contained in main memory 2015 causes the computing system 2000 to perform the illustrative processes described herein. One or more processors in a multi-processing arrangement may also be employed to execute the instructions contained in main memory 2015. Hard-wired circuitry can be used in place of or in combination with software instructions together with the systems and methods described herein. Systems and methods described herein are not limited to any specific combination of hardware circuitry and software.

Although an example computing system has been described in FIG. 20, the subject matter including the operations described in this specification can be implemented in other types of digital electronic circuitry, or in computer software, firmware, or hardware, including the structures disclosed in this specification and their structural equivalents, or in combinations of one or more of them. As such, the techniques may transform the computing device 2000 into a special purpose device for providing aerial navigation control.

Some of the description herein emphasizes the structural independence of the aspects of the system components, such as components of the electrical system of the AV, which illustrates one grouping of operations and responsibilities of these system components. Other groupings that execute similar overall operations are understood to be within the scope of the present application. Modules can be implemented in hardware or as computer instructions on a non-transient computer readable storage medium, and modules can be distributed across various hardware or computer-based components.

The systems described above can provide multiple ones of any or each of those components and these components can be provided on either a standalone system or on multiple instantiation in a distributed system. In addition, the systems and methods described above can be provided as one or more computer-readable programs or executable instructions embodied on or in one or more articles of manufacture. The article of manufacture can be cloud storage, a hard disk, a CD-ROM, a flash memory card, a PROM, a RAM, a ROM, or a magnetic tape. In general, the computer-readable programs can be implemented in any programming language, such as C, C++, C #, or in any byte code language such as JAVA or Python. The software programs or executable instructions can be stored on or in one or more articles of manufacture as object code.

Example and non-limiting module implementation elements include sensors providing any value determined herein, sensors providing any value that is a precursor to a value determined herein, datalink or network hardware including communication chips, oscillating crystals, communication links, cables, twisted pair wiring, coaxial wiring, shielded wiring, transmitters, receivers, or transceivers, logic circuits, hard-wired logic circuits, reconfigurable logic circuits in a particular non-transient state configured according to the module specification, any actuator including at least an electrical, hydraulic, or pneumatic actuator, a solenoid, an op-amp, analog control elements (springs, filters, integrators, adders, dividers, gain elements), or digital control elements.

The subject matter and the operations described in this specification can be implemented in digital electronic circuitry, or in computer software, firmware, or hardware, including the structures disclosed in this specification and their structural equivalents, or in combinations of one or more of them. The subject matter described in this specification can be implemented as one or more computer programs, e.g., one or more circuits of computer program instructions, encoded on one or more computer storage media for execution by, or to control the operation of, data processing apparatuses. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. While a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices include cloud storage). The operations described in this specification can be implemented as operations performed by a data processing apparatus on data stored on one or more computer-readable storage devices or received from other sources.

The terms “computing device”, “component” or “data processing apparatus” or the like encompass various apparatuses, devices, and machines for processing data, including by way of example a programmable processor, a computer, a system on a chip, or multiple ones, or combinations of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, app, script, or code) can be written in any form of programming language, including compiled or interpreted languages, declarative or procedural languages, and can be deployed in any form, including as a stand-alone program or as a module, component, subroutine, object, or other unit suitable for use in a computing environment. A computer program can correspond to a file in a file system. A computer program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatuses can also be implemented as, special purpose logic circuitry, e.g., an FPGA (field programmable gate array) or an ASIC (application specific integrated circuit). Devices suitable for storing computer program instructions and data can include non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

The subject matter described herein can be implemented in a computing system that includes a back end component, e.g., as a data server, or that includes a middleware component, e.g., an application server, or that includes a front end component, e.g., a client computer having a graphical user interface or a web browser through which a user can interact with an implementation of the subject matter described in this specification, or a combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

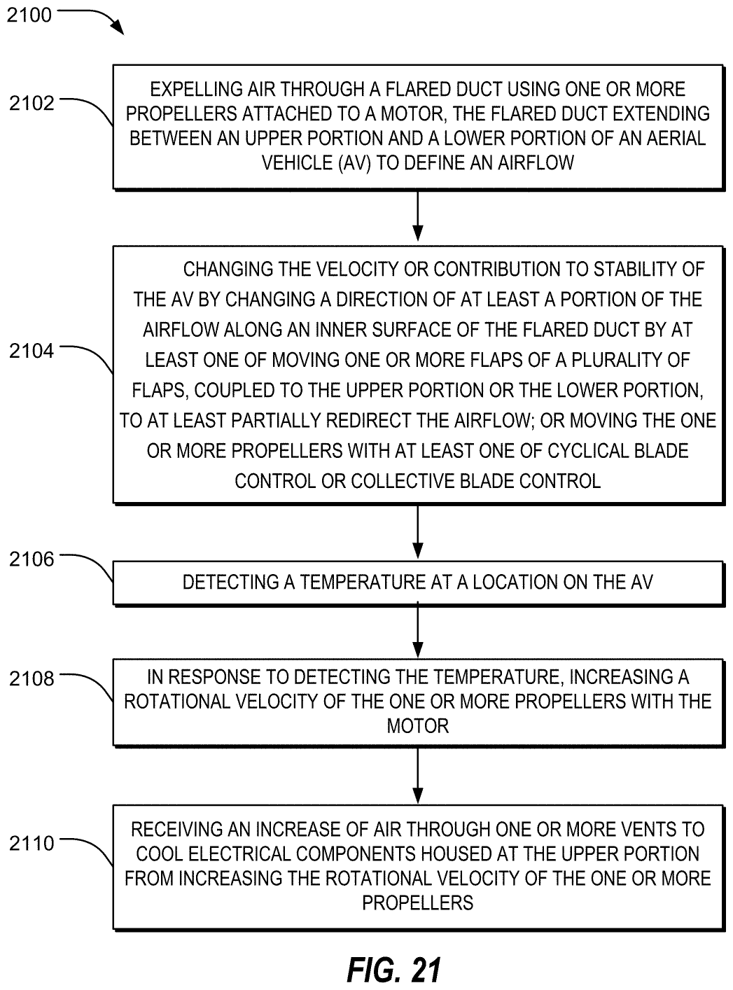

Turning to FIG. 21, an example method 2100 of controlling an aerial vehicle (AV) is depicted. In some instances, an operation 2102 generates an airflow by directing air through a flared duct using one or more propellers, thereby moving the AV at a velocity. The flared duct may extend between an upper portion and a lower portion of the AV, defining the airflow. An operation 2104 changes the velocity or contribution to the stability of the AV by changing a direction of at least a portion of the airflow along an inner surface of the flared duct. For example, the operation 2104 may change the direction of airflow by moving one or more flaps of a plurality of flaps, coupled to the upper portion or the lower portion, to at least partially redirect the airflow. In another example, the AV may include propeller blades arranged with a swash plate, and the operation 2104 may change the direction of airflow using cyclical blade control or collective blade control only, or a combination using cyclical blade control or collective blade control while moving one or more flaps. In this manner, the blades may rotate or otherwise move cyclically to redirect airflow. In some instances, an operation 2106 detects a temperature at a location on the AV, and, at operation 2108, in response to detecting the temperature, increases a rotational velocity of the one or more propellers. An operation 2110 may receive an increase of air through one or more vents increase of air through one or more vents to cool electrical components housed at the upper frame from increasing the rotational velocity of the one or more propellers.

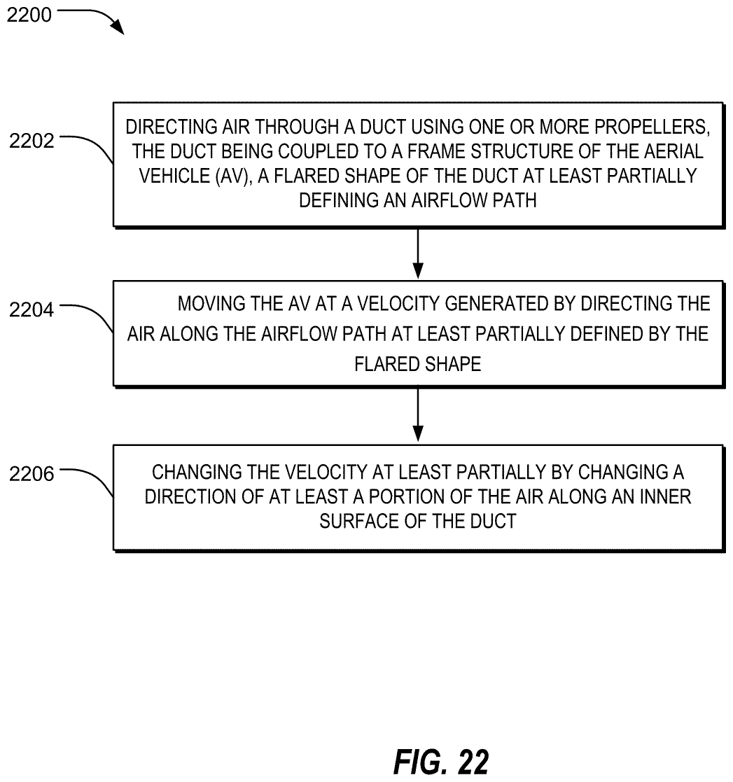

Turning to FIG. 22, an example method 2200 of controlling an aerial vehicle (AV) is depicted. In some instances, an operation 2202 includes directing air through a duct using one or more propellers, the duct being coupled to a frame structure of the AV, a flared shape of the duct at least partially defining an airflow path. An operation 2204 may move the AV at a velocity generated by directing the air along the airflow path at least partially defined by the flared shape. In some instances, an operation 2206 changes the velocity at least partially by changing a direction of at least a portion of the air along an inner surface of the duct. Operation 2206 can include moving one or more flaps of a plurality of flaps to at least partially redirect the airflow path; and/or protruding the plurality of flaps such that the plurality of flaps overlap with one another. Additionally or alternatively, operation 2206 includes cyclically or collectively controlling a pitch of the at least one blade of the at least one propeller to change a thrust vector direction while omitting a usage of the plurality of flaps.

While operations are depicted in the drawings in a particular order, such operations are not required to be performed in the particular order shown or in sequential order, and all illustrated operations are not required to be performed. Operations of the methods described herein can be performed in a different order, omitted, repeated, performed in parallel, and/or combined with other operations. Any of the operations depicted in FIGS. 1-22 can be combined with any other operations depicted in FIGS. 1-22.

Having now described some illustrative implementations, it is apparent that the foregoing is illustrative and not limiting, having been presented by way of example. In particular, although many of the examples presented herein involve specific combinations of method acts or system elements, those acts and those elements may be combined in other ways to accomplish the same objectives. Acts, elements and features discussed in connection with one implementation are not intended to be excluded from a similar role in other implementations or implementations. The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular may also embrace implementations including a plurality of these elements, and any references in plural to any implementation or element or act herein may also embrace implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

Any implementation disclosed herein may be combined with any other implementation or embodiment, and references to “an implementation,” “some implementations,” “one implementation” or the like are not necessarily mutually exclusive and are intended to indicate that a particular feature, structure, or characteristic described in connection with the implementation or embodiment. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. For example, a reference to “at least one of ‘A’ and 13’ can include only ‘A’, only 13’, as well as both ‘A’ and 13’. Such references used in conjunction with “comprising” or other open terminology can include additional items.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

The systems and methods described herein may be embodied in other specific forms without departing from the characteristics thereof. Scope of the systems and methods described herein is thus indicated by the appended claims, rather than the foregoing description, and changes that come within the meaning and range of equivalency of the claims are embraced therein.

What is claimed is:

1. An aerial vehicle (AV) comprising:
a frame structure;
a duct extending at least partially within the frame structure;
at least one motor configured to rotate at least one propeller within the duct, the duct at least partially defining an airflow pathway; and
a plurality of flaps, at least one of the plurality of flaps configured to move to at least partially redirect the airflow pathway.

2. The AV of claim 1, further comprising:
at least one vent configured to receive air moved by the at least one propeller within the duct, the air received within the at least one vent creating passive cooling for one or more electrical components.

3. The AV of claim 1, wherein the frame structure further comprises a plurality of bridges connecting an upper portion of the frame structure to a lower portion of the frame structure to form a plurality of openings between the upper portion and the lower portion.

4. The AV of claim 1, further comprising:
a controller configured to:
detect a temperature of a housing of the AV;
responsive to the temperature of the housing being greater than a temperature threshold, initiate a cooling protocol configured to reduce the temperature of the housing without increasing an altitude of the AV; and
cause a rate of rotation of the at least one propeller to increase or decrease based on the cooling protocol.

5. The AV of claim 1, further comprising:
a controller configured to:
adjust, based on feedback data of one or more sensors, a rate of rotation of the at least one propeller to at least one of increase or decrease an altitude of the AV; and
adjust, based on the feedback data, a level of protrusion of one or more of the plurality of flaps to redirect the AV.

6. The AV of claim 1, further comprising:
at least one battery unit forming an aerodynamic portion of at least one of an upper portion of the frame structure or a lower portion of the frame structure, the at least one battery unit providing power to one or more electrical components of the AV.

7. The AV of claim 6, wherein the one or more electrical components are disposed in at least a first housing, and the at least one battery unit is disposed in at last one of a second housing, a third housing, or a fourth housing for one or more battery cells, the first housing, the second housing, the third housing, and the fourth housing form the upper portion.

8. The AV of claim 1, wherein the duct has a flared shape from an upper portion of the frame structure to a lower portion of the frame structure, such that an upper end of the duct comprises a smaller diameter than a lower end of the duct, the flared shape of the duct redirecting airflow towards an inner wall of the duct.

9. The AV of claim 1, wherein the at least one propeller comprises a first propeller adjacent to an upper end of the duct and a second propeller adjacent to a lower end of the duct, the first propeller being smaller than the second propeller.

10. The AV of claim 1, comprising:
a detachable cover between an upper portion of the frame structure and a lower portion of the frame structure to cover a plurality of openings formed by a plurality of bridges between the upper portion and the lower portion.

11. The AV of claim 10, wherein the detachable cover includes one or more active or passive components to provide a supplemental capability to the AV, the one or more active or passive components including at least one of an antennas, a sensor, or an actuator.

12. The AV of claim 1, wherein at least one of the plurality of flaps comprises a rigid guide portion to couple with a guide coupled to the frame structure to provide retractability for the at least one of the plurality of flaps.

13. The AV of claim 1, wherein the plurality of flaps are disposed proximate to a lower frame of the frame structure and a lower end of the duct to redirect airflow in a predetermined direction to control movement of the AV.

14. The AV of claim 1, wherein a plurality of actuators drive the plurality of flaps to protrude or retract via a plurality of guides.

15. A system comprising:
an aerial vehicle (AV) including:
a frame structure comprising a housing for one or more electrical components configured to control movement of the AV;
a duct coupled to the frame structure having a flared shape defining an airflow path;
at least one motor coupled to the one or more electrical components and at least one propeller, the at least one motor configured to rotate the at least one propeller directed along the airflow path;
a plurality of actuators coupled to the frame structure and the one or more electrical components; and
a plurality of flaps, coupled to a plurality of guides and the plurality of actuators, configured to protrude into or retract from the airflow path via the plurality of guides.

16. The system of claim 15, wherein the frame structure further comprises a plurality of bridges connecting an upper portion and a lower portion to form a plurality of openings between the upper portion and the lower portion.

17. The system of claim 15, wherein a pitch of at least one blade of the at least one propeller has cyclical or collective control to change a thrust vector direction omitting a usage of the plurality of flaps.

18. The system of claim 17, further comprising:
a plurality of guides located between a plurality of bridges of the frame structure and the duct, at least one of the plurality of guides forming a path for at least one of the plurality of flaps.

19. A method of controlling an aerial vehicle (AV) including:
directing air through a duct using one or more propellers, the duct being coupled to a frame structure of the AV, a flared shape of the duct at least partially defining an airflow path;
moving the AV at a velocity generated by directing the air along the airflow path at least partially defined by the flared shape; and
changing the velocity at least partially by changing a direction of at least a portion of the air along an inner surface of the duct.

20. The method of claim 19, wherein changing the velocity includes at least one of:
moving one or more flaps of a plurality of flaps to at least partially redirect the airflow path; or
protruding the plurality of flaps such that the plurality of flaps overlap with one another.

21. The method of claim 19, wherein the direction of at least a portion of the airflow path is changed by changing an orientation of the one or more propellers.

22. The method of claim 19, further comprising:
detecting a temperature at a location within the AV;
in response to detecting the temperature, increasing a rotational velocity of the one or more propellers; and
receiving an increase of air through one or more vents, the increase in air generated by increasing the rotational velocity of the one or more propellers and causing the temperature to decrease.

23. The method of claim 19, wherein changing the velocity includes cyclically or collectively controlling a pitch of at least one blade of at least one propeller to change a thrust vector direction of the AV.

24. The method of claim 23, wherein changing the velocity omits a usage of a plurality of flaps.
